(19) United States
(12) Patent Application Publication
(10) Pub. No.: US 2025/0253992 A1
(43) Pub. Date: Aug. 7, 2025

(54) TECHNIQUES TO FACILITATE PARAMETER COMBINATION CONFIGURATIONS FOR TYPE-II-CJT CSI

(71) Applicant: QUALCOMM Incorporated, San Diego, CA (US)

(72) Inventors: Jing DAI, Beijing (CN); Liangming WU, Beijing (CN); Wei XI, Beijing (CN); Chenxi HAO, Beijing (CN); Chao WEI, Beijing (CN); Min HUANG, Beijing (CN); Hao XU, Beijing (CN)

(21) Appl. No.: 19/108,716

(22) PCT Filed: Sep. 29, 2022
(86) PCT No.: PCT/CN2022/122512

§ 371 Date: Mar. 4, 2025

(51) Int. Cl. H04L 5/00; H04B 7/06; H04W 72/23

(52) U.S. Cl. CPC H04L 5/0035; H04B 7/0626; H04W 72/23

(57) ABSTRACT

In a first configuration, a UE is configured to transmit information indicating a number of SD bases for each TRP of a set of TRPs. In addition, the UE is configured to receive a downlink communication from at least a subset of TRPs of the set of TRPs based on the transmitted information. In a second configuration, a UE is configured to receive information indicating a number of SD bases for each TRP of a set of TRPs. The received information is unassociated with a first parameter indicating a number of FD bases and a second parameter indicating a maximum number of NZCs. In addition, the UE is configured to transmit a CSI report based on the received information.

### TECHNICAL FIELD

The present disclosure relates generally to communication systems, and more particularly, to wireless communications employing coherent joint transmissions (CJT) across multiple transmission reception points (TRPs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication. An apparatus may include a user equipment (UE). The example apparatus may transmit information indicating a number of spatial domain (SD) bases for each transmission reception point (TRP) of a set of TRPs. The example apparatus may also receive downlink communication from at least a subset of TRPs of the set of TRPs based on the information.

In another aspect of the disclosure, a method, a computer-readable medium, and an apparatus are provided for wireless communication. An apparatus may include a UE. The example apparatus may receive information indicating a number of SD bases for each TRP of a set of TRPs, the information being unassociated with a first parameter indicating a number of frequency domain (FD) bases and a second parameter indicating a maximum number of non-zero coefficients (NZCs). The example apparatus may also transmit a channel state information (CSI) report based on the information.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a wireless communications system including a UE, a first network entity, a second network entity, and multiple TRPs, in accordance with various aspects of the present disclosure.

FIG. 5A is a diagram illustrating characteristics of a non-coherent joint transmission (NCJT), in accordance with various aspects of the present disclosure.

FIG. 5B is a diagram illustrating characteristics of a coherent joint transmission (CJT), in accordance with various aspects of the present disclosure.

FIG. 6 is a diagram illustrating components of a precoder matrix in some aspects of wireless communication, in accordance with various aspects of the present disclosure.

FIG. 7 is a diagram illustrating a set of precoder components used in some aspects of CJT, in accordance with various aspects of the present disclosure.

FIG. 8 depicts a table illustrating different combinations of the parameters based on a value of a parameter combination indicator, in accordance with various aspects of the present disclosure.

FIG. 9 is a diagram illustrating an example of a two part CSI, in accordance with various aspects of the present disclosure.

FIG. 10 illustrates an example communication flow between a network entity and a UE, in accordance with various aspects of the present disclosure.

FIG. 11 depicts a table illustrating difference cases based on TRP selection and number of SD bases configuration, in accordance with various aspects of the present disclosure.

FIG. 12 depicts a portion of a table illustrating different combinations of the parameters based on a value of a parameter combination indicator, in accordance with various aspects of the present disclosure.

FIG. 13 is a diagram illustrating an example CSI report including a first CSI part and a second CSI part, in accordance with various aspects of the present disclosure.

FIG. 14 is a diagram illustrating another example CSI report including a first CSI part and a second CSI part, in accordance with various aspects of the present disclosure.

FIG. 15 is a diagram illustrating another example CSI report including a first CSI part and a second CSI part, in accordance with various aspects of the present disclosure.

FIG. 16 is a diagram illustrating another example CSI report including a first CSI part and a second CSI part, in accordance with various aspects of the present disclosure.

FIG. 17 depicts portions of tables illustrating different combinations of parameters based on a value of a parameter combination indicator, in accordance with various aspects of the present disclosure.

FIG. 18 is a diagram illustrating another example CSI report including a first CSI part and a second CSI part, in accordance with various aspects of the present disclosure.

FIG. 19 is a flowchart of a method of wireless communication, in accordance with various aspects of the present disclosure.

FIG. 20 is a flowchart of a method of wireless communication, in accordance with various aspects of the present disclosure.

FIG. 21 is a diagram illustrating an example of a hardware implementation for an example apparatus and/or network entity.

### DETAILED DESCRIPTION

In some examples, wireless communications systems may support connectivity for a large number of UEs. Such wireless communications systems may include multiple TRPs to, for example, improve reliability, coverage, and/or capacity. In a multiple TRP communications system, a network entity and a UE may communicate with each other by sending communications using one or more of the multiple TRPs.

A channel state feedback procedure may facilitate channel estimation at a UE. For example, the channel state feedback procedure may include the UE receiving a CSI reference signal (CSI-RS) from a network entity. The UE may generate (or measure) CSI based on, for example, the CSI-RS, and transmit a CSI report including the CSI to the network entity. In some examples, the network entity may transmit a downlink communication to the UE based on the CSI included in the CSI report. In examples in which the network entity and the UE are operating in a multiple TRP communication mode, the UE may generate CSI for one or more of the TRPs when performing a channel state feedback procedure. Thus, it may be appreciated that as the quantity of TRPs increases, the size of the CSI report may also increase.

Aspects disclosed herein provide techniques for improving CSI acquisition for CJT targeting low frequency bands, such as FR1, and up to 4 TRPs. In such scenarios, it may be appreciated that the backhaul connection between the TRPs is ideal and synchronization (e.g., coordination of transmissions) is supported. Additionally, the quantity of antenna ports across all of the TRPs may be the same. Thus, aspects disclosed herein may facilitate providing Type-II codebook refinement for CJT in a multiple TRP (mTRP) communication mode targeting FDD and its associated CSI reporting, while also considering a trade-off between throughput and overhead.

Aspects disclosed herein facilitate enabling a larger number of ports for CJT in low-frequency bands and with distributed TRPs/panels. For example, for a single TRP/panel with, for example, 32 ports, the antenna array size may become too large for practical deployment.

In a first aspect disclosed herein, the UE may transmit information indicating a number of SD bases for each TRP of a set of TRPs. The UE may indicate the number of SD bases in a CSI part 1 of a CSI report or in a CSI part 2 of the CSI report. The UE may then receive a downlink communication from at least a subset of TRPs of the set of TRPs.

In a second aspect disclosed herein, the UE may receive information indicating a number of SD bases for each TRP of a set of TRPs. The received information may be unassociated with a first parameter indicating a number of FD bases and a second parameter indicating a maximum number of NZCs. The UE may also transmit a CSI report based on the received information. The UE may include an indication of selected TRPs in a CSI part 1 of the CSI report, and include an indication of per-TRP SD basis selection in a CSI part 2 of the CSI report.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

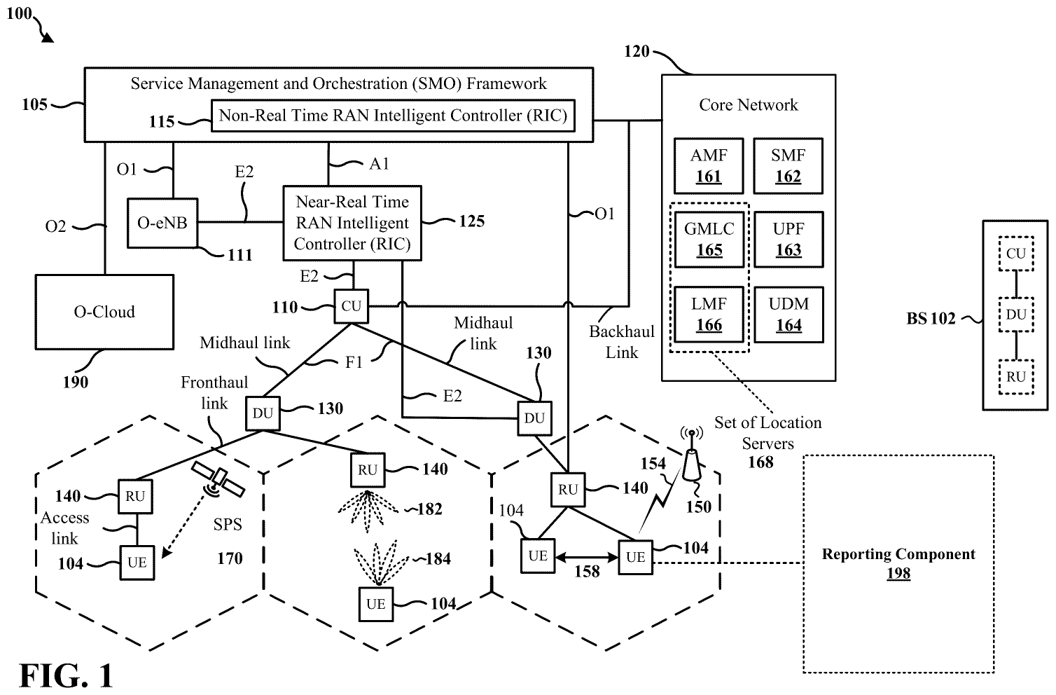

FIG. 1 is a diagram 100 illustrating an example of a wireless communications system and an access network. The illustrated wireless communications system includes a disaggregated base station architecture. The disaggregated base station architecture may include one or more CUs (e.g., a CU 110) that can communicate directly with a core network 120 via a backhaul link, or indirectly with the core network 120 through one or more disaggregated base station units (such as a Near-Real Time (Near-RT) RAN Intelligent Controller (RIC) (e.g., a Near-RT RIC 125) via an E2 link, or a Non-Real Time (Non-RT) RIC 115 associated with a Service Management and Orchestration (SMO) Framework (e.g., an SMO Framework 105), or both). A CU 110 may communicate with one or more DUs (e.g., a DU 130) via respective midhaul links, such as an F1 interface. The DU 130 may communicate with one or more RUs (e.g., an RU 140) via respective fronthaul links. The RU 140 may communicate with respective UEs (e.g., a UE 104) via one or more radio frequency (RF) access links. In some implementations, the UE 104 may be simultaneously served by multiple RUS.

Each of the units, i.e., the CUS (e.g., a CU 110), the DUs (e.g., a DU 130), the RUs (e.g., an RU 140), as well as the Near-RT RICs (e.g., the Near-RT RIC 125), the Non-RT RICs (e.g., the Non-RT RIC 115), and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU 140 can be implemented to handle over the air (OTA) communication with one or more UEs (e.g., the UE 104). In some implementations, real-time and non-real-time aspects of control and user plane communication with the RU 140 can be controlled by a corresponding DU. In some scenarios, this configuration can enable the DU(s) and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs, DUs, RUS and Near-RT RICs. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs (e.g., the RU 140) and the UEs (e.g., the UE 104) may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UE 104 may use spectrum up to Y MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication (e.g., a D2D communication link 158). The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with a UE 104 (also referred to as Wi-Fi stations (STAs)) via communication link 154, e.g., in a 5 GHz unlicensed frequency spectrum or the like. When communicating in an unlicensed frequency spectrum, the UE 104/Wi-Fi AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) (e.g., an AMF 161), a Session Management Function (SMF) (e.g., an SMF 162), a User Plane Function (UPF) (e.g., a UPF 163), a Unified Data Management (UDM) (e.g., a UDM 164), one or more location servers 168, and other functional entities. The AMF 161 is the control node that processes the signaling between the UE 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) (e.g., a GMLC 165) and a Location Management Function (LMF) (e.g., an LMF 166). However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station (e.g., the base station 102). The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a device in communication with a base station, such as a UE 104 in communication with a network entity, such as a base station 102 or a component of a base station (e.g., a CU 110, a DU 130, and/or an RU 140), may be configured to manage one or more aspects of wireless communication. For example, the UE 104 may include a reporting component 198 configured to enable a larger number of ports for CJT in low-frequency bands and with distributed TRPs/panels.

In certain aspects, the reporting component 198 may be configured to transmit information indicating a number of SD bases for each TRP of a set of TRPs. The example reporting component 198 may also be configured to receive downlink communication from at least a subset of TRPs of the set of TRPs based on the information.

In certain aspects, the reporting component 198 may be configured to receive information indicating a number of SD bases for each TRP of a set of TRPs. In some examples, the information may be unassociated with a first parameter indicating a number of FD bases and a second parameter indicating a maximum number of NZCs. The example reporting component 198 may also be configured to transmit a CSI report based on the information.

Although the following description may be focused on 5G NR, the concepts described herein may be applicable to other similar areas, such as LTE, LTE-A, CDMA, GSM, 6G, and other wireless technologies.

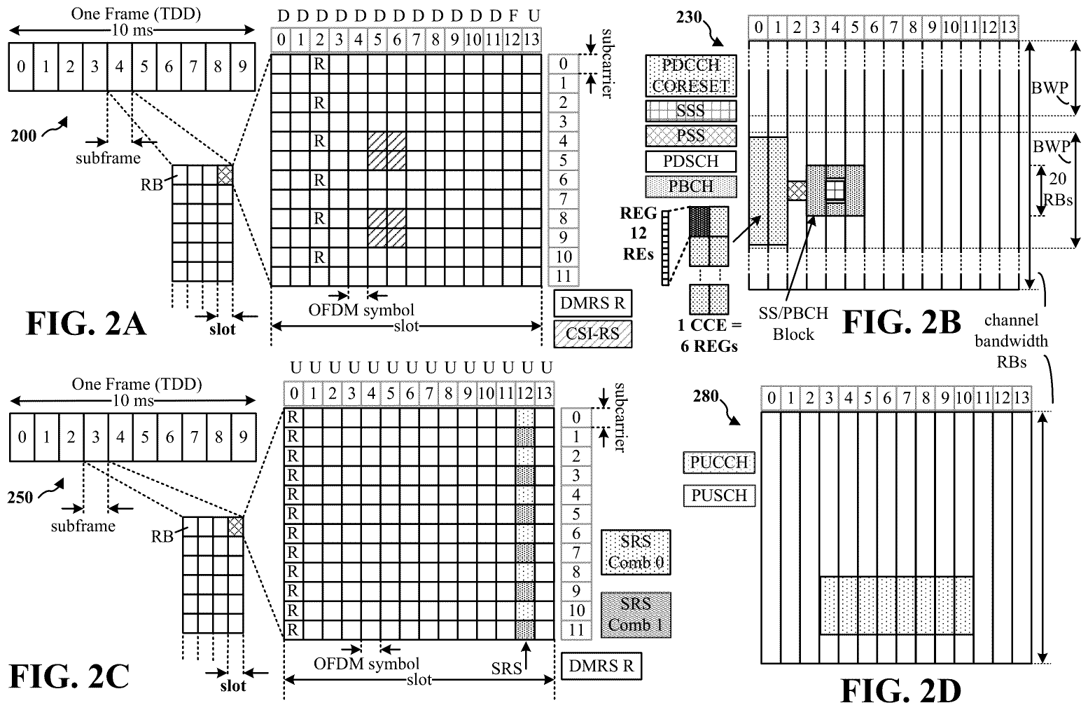

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. As shown in Table 1, the subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

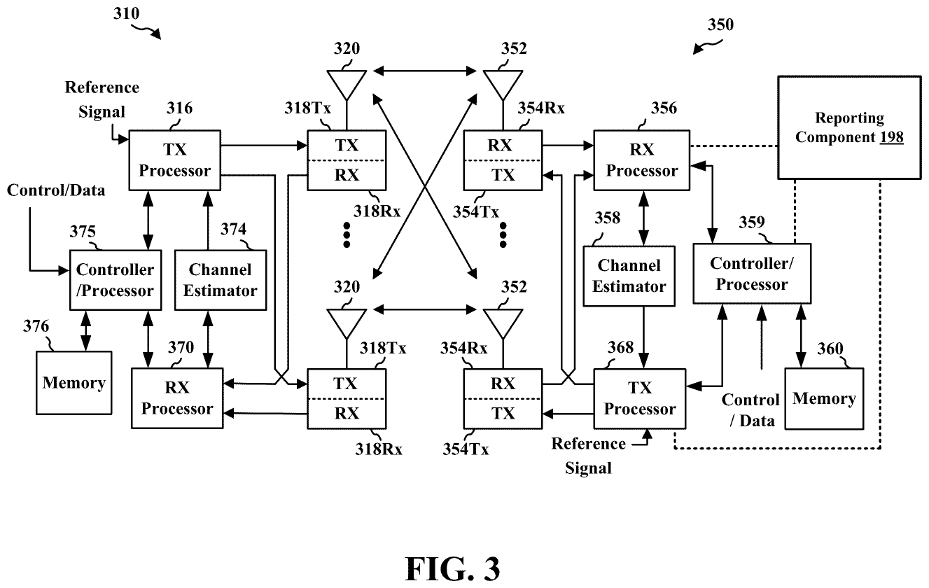

FIG. 3 is a block diagram that illustrates an example of a first wireless device that is configured to exchange wireless communication with a second wireless device. In the illustrated example of FIG. 3, the first wireless device may include a base station 310, the second wireless device may include a UE 350, and the base station 310 may be in communication with the UE 350 in an access network. As shown in FIG. 3, the base station 310 includes a transmit processor (TX processor 316), a transmitter 318Tx, a receiver 318Rx, antennas 320, a receive processor (RX processor 370), a channel estimator 374, a controller/processor 375, and memory 376. The example UE 350 includes antennas 352, a transmitter 354Tx, a receiver 354Rx, an RX processor 356, a channel estimator 358, a controller/processor 359, memory 360, and a TX processor 368. In other examples, the base station 310 and/or the UE 350 may include additional or alternative components.

In the DL, Internet protocol (IP) packets may be provided to the controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 316 and the RX processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna of the antennas 320 via a separate transmitter (e.g., the transmitter 318Tx). Each transmitter 318Tx may modulate a radio frequency (RF) carrier with a respective spatial stream for transmission.

At the UE 350, each receiver 354Rx receives a signal through its respective antenna of the antennas 352. Each receiver 354Rx recovers information modulated onto an RF carrier and provides the information to the RX processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, two or more of the multiple spatial streams may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with the memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna of the antennas 352 via separate transmitters (e.g., the transmitter 354Tx). Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna of the antennas 320. Each receiver 318Rx recovers information modulated onto an RF carrier and provides the information to the RX processor 370.

The controller/processor 375 can be associated with the memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the reporting component 198 of FIG. 1.

In some examples, wireless communications systems may support connectivity for a large number of UEs. Such wireless communications systems may include multiple TRPs to, for example, improve reliability, coverage, and/or capacity. In a multiple TRP communications system, a network entity and a UE may communicate with each other by sending communications using one or more of the multiple TRPs. For example, the network entity may connect to multiple geographically-distributed TRPs, which may then separately or jointly output communications to one or more UEs and/or may separately or jointly obtain communications from or more UEs. For example, a network entity may connect with a first TRP and a second TRP, which may each be connected with a UE. In some such examples, the network entity and the UE may communicate (e.g., transmit and/or receive communications) via the first TRP, may communicate via the second TRP, or may communicate via the first TRP and the second TRP.

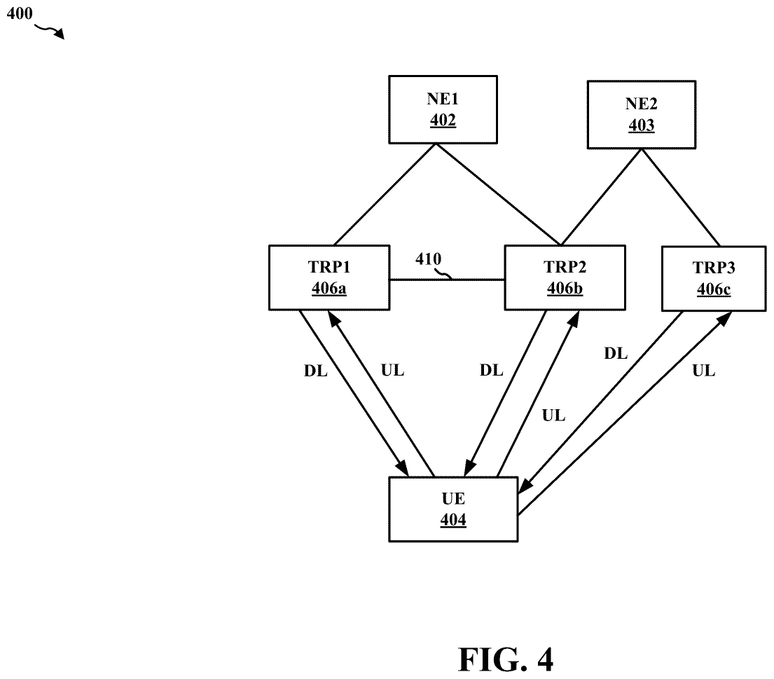

FIG. 4 is a diagram illustrating an example of a wireless communications system 400 including a UE 404, a first network entity 402 (“NE1”), a second network entity 403 (“NE2”), and multiple TRPs, as presented herein. In the illustrated example of FIG. 4, the first network entity 402 and the UE 404 are operating in a multiple TRP communication mode in which the first network entity 402 is in communication with a first TRP 406a (“TRP1”) and a second TRP 406b (“TRP2”), which are each connected to the UE 404. Accordingly, communications between the first network entity 402 and the UE 404 may be communicated via one or both of the first TRP 406a and the second TRP 406b. For example, with respect to a downlink communication output by the first network entity 402 to the UE 404, the downlink communication may be output by the first network entity 402 to one or both of the first TRP 406a and the second TRP 406b, and then by the one or both of the first TRP 406a and the second TRP 406b to the UE 404.

When employing a multiple TRP communication mode, communications may comprise a joint transmission in which multiple TRPs contemporaneously transmit data, for example, to a UE. A joint transmission may comprise a coherent joint transmission (CJT) or a non-coherent joint transmission (NCJT). A joint transmission may be an NCJT when data (e.g., layers) may be precoded separately on different TRPs. The joint transmission may be a CJT when a same layer may be transmitted via multiple TRPs with phase coherence. In some aspects, the coherence of a CJT may refer to a phase coherence between TRPs that may be transmitting a same layer as opposed to an NCJT in which each layer is transmitted via a single TRP and phase coherence between the TRPs may not provide additional benefits. In some examples, a joint transmission may be coherent when the multiple TRPs are able to coordinate with each other, for example, via a backhaul connection. However, when the multiple TRPs are unable to coordinate, for example, due to a non-ideal backhaul, the joint scheduling between the respective TRPs may not be feasible (e.g., due to a delay associated with coordinating control signaling and/or data, and/or limited backhaul capacity).

For example, in the illustrated example of FIG. 4, the first TRP 406a and the second TRP 406b may establish a backhaul connection 410 that enables the first TRP 406a and the second TRP 406b to coordinate joint transmissions (e.g., coherent joint transmissions). Accordingly, the first TRP 406a and the second TRP 406b may coordinate when transmitting communications between the first network entity 402 and the UE 404. For example, the first TRP 406a and the second TRP 406b may coordinate transmissions to reduce interference or overlapping of signals.

In other examples, one or more of the TRPs may not be unable to coordinate joint transmissions. For example, similar to the first network entity 402, the second network entity 403 may also in a multiple TRP communication mode with the UE 404. For example, the second network entity 403 may be in communication with the second TRP 406b and a third TRP 406c (“TRP3”), which are each in communication with the UE 404. Accordingly, a communication communicated between the second network entity 403 and the UE 404 may be communicated via one or both of the second TRP 406b and the third TRP 406c. In the example of FIG. 4, the second TRP 406b and the third TRP 406c may be unable to establish a backhaul connection and/or may establish a non-ideal backhaul connection. In such scenarios, while the second TRP 406b and the third TRP 406c may support joint transmissions, the joint transmissions may be NCJTs.

Although the description of FIG. 4 provides an example in which the wireless communications system 400 includes three TRPs, in other examples, the wireless communications system may include any suitable quantity of TRPs. Additionally, other examples may include any suitable quantity of TRPs that facilitate coherent joint transmissions, and/or any suitable quantity of TRPs that facilitate non-coherent joint transmissions.

A channel state feedback procedure may facilitate channel estimation at a UE. For example, the channel state feedback procedure may include the UE receiving a CSI-RS from a network entity. The UE may generate (or measure) CSI based on, for example, the CSI-RS, and transmit a CSI report including the CSI to the network entity. The CSI generated by the UE may include one or more components, such as a CSI-RS resource indicator (CRI), a rank indicator (RI), a channel quality indicator (CQI), a precoding matrix indicator (PMI), a layer indicator (LI), etc. In some examples, the network entity may transmit a downlink communication to the UE based on the CSI included in the CSI report. In examples in which the network entity and the UE are operating in a multiple TRP communication mode, the UE may generate CSI for one or more of the TRPs when performing a channel state feedback procedure. Thus, it may be appreciated that as the quantity of TRPs increases, the size of the CSI report may also increase.

Aspects disclosed herein provide techniques for improving CSI acquisition for CJT targeting low frequency bands, such as FR1, and up to 4 TRPs. In such scenarios, it may be appreciated that the backhaul connection between the TRPs is ideal and synchronization (e.g., coordination of transmissions) is supported. Additionally, the quantity of antenna ports across all of the TRPs may be the same. Thus, aspects disclosed herein may facilitate providing Type-II codebook refinement for CJT in a multiple TRP (mTRP) communication mode targeting FDD and its associated CSI reporting, while also considering (e.g., taking into account) a trade-off between throughput and overhead.

Aspects disclosed herein facilitate enabling a larger number of ports for CJT in low-frequency bands and with distributed TRPs/panels. For example, for a single TRP/panel with, for example, 32 ports, the antenna array size may become too large for practical deployment.

In the examples disclosed herein, the maximum number of CSI-RS ports per resource remains 32 ports.

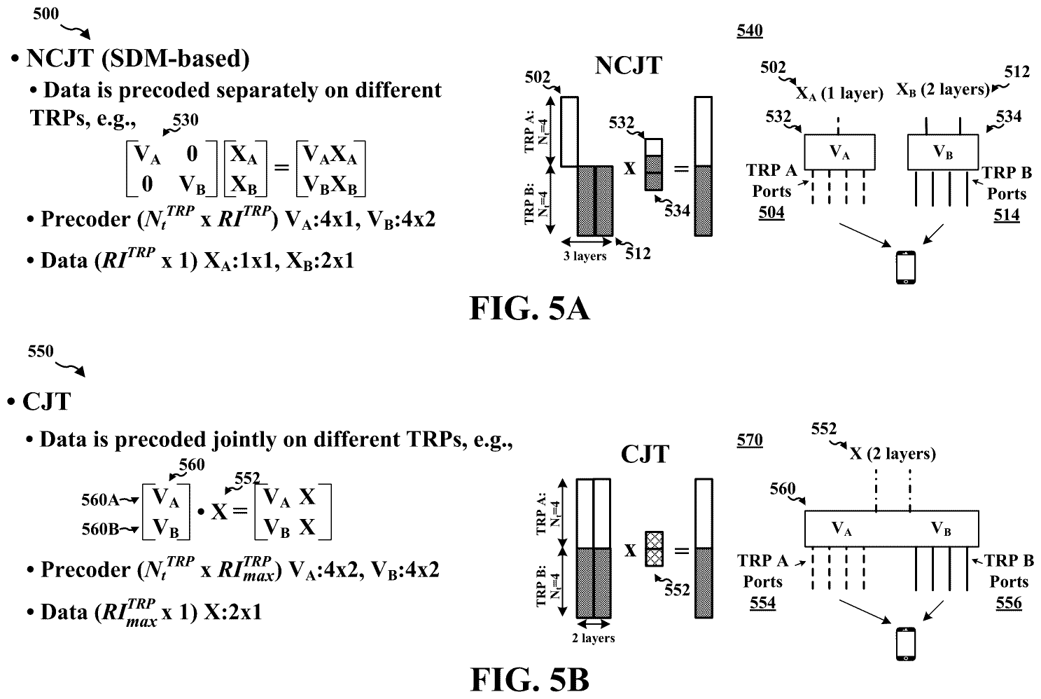

FIG. 5A is a diagram 500 illustrating characteristics of a NCJT, as presented herein. The diagram 500 illustrates that for NCJT, a first set of layers (e.g., a set of one layer) associated with first data 502 (“X_{A}”) may be associated with a first set of TRP ports (e.g., ports of a first TRP 504 (“TRP A”)) while a second set of layers (e.g., a set of two layers) associated with second data 512 (“X_{B}”) may be associated with a second set of TRP ports (e.g., ports of a second TRP 514 (“TRP B”)). For NCJT, the first data 502 and the second data 512 may be precoded with a precoder matrix 530.

The data may be precoded separately on different TRPs. For example, a first column of the precoder matrix 530 indicates that, at a first instance, the first TRP 504 will transmit data and the value “0” indicates that the second TRP 514 will not transmit data. Then, the second column of the precoder matrix 530 indicates that, at a second instance, the first TRP 504 does not transmit (e.g., based on the value “0”) and that the second TRP 514 will transmit. In the example of FIG. 5A, data is represented by X_{A} (e.g., the first data 502) and X_{B} (e.g., the second data 512) in which the first data 502 is precoded based on a first precoder component 532 (“V_{A}”) and the second data 512 is precoded based on second precoder component 534 (“V_{B}”) for transmission over the first TRP 504 and the second TRP 514, respectively.

In the illustrated example of FIG. 5A, the precoder matrix 530 may have a dimension based on Nₜ^{TRP}×RI^{TRP}, where N^{TRP} is a value based on a number of transmission antennas of a TRP and RI^{TRP} corresponds to a rank indicator (RI) for the TRP, e.g., a number of layers for the TRP. In FIG. 5A, the first TRP 504 includes four antenna ports and 1 layer, e.g., corresponding to the first precoder component 532 having dimensions of 4×1, whereas the second TRP 514 includes four antenna ports and two layers, e.g., corresponding to the second precoder component 534 having dimensions of 4×2. The data may be based on the RI of the corresponding TRP×1, e.g., RI^{TRP}×1, so that the first data 502 for the first TRP 504 has dimensions 1×1, and the second data 512 for the second TRP 514 has dimensions 2×1. In the example of FIG. 5A, the diagram 500 includes a mapping 540 of the data for transmission on the TRPs.

FIG. 5B is a diagram 550 illustrating characteristics of a CJT, as presented herein. The diagram 550 illustrates that, as opposed to NCJT, for CJT a first set of layers (e.g., a set of 2 layers) associated with joint data 552 (“X”) may be jointly precoded to be transmitted from both a first TRP and a second TRP in a coherent manner via first TRP ports 554 and second TRP ports 556. For example, the joint data 552 may be precoded based on a precoder matrix 560 including a first precoder component 560A (“V_{A}”) and a second precoder component 560B (“V_{B}”).

FIG. 5B illustrates that the precoder matrix 560 may have dimensions based on Nₜ^{TRP}×RIₘₐₓ^{TRP}, where Nₜ^{TRP} is a value based on a number of transmission antennas of a TRP and RIₘₐₓ^{TRP} corresponds to a maximum rank indicator for the TRPs, e.g., a maximum number of layers for the TRPs. In the example of FIG. 5B, the first TRP and the second TRP each have four antenna ports and a maximum of 2 layers, so that the dimensions of the first precoder component 560A and the second precoder component 560B are each 4×2. The data may be based on the RIₘₐₓ^{TRP}×1, e.g., RIₘₐₓ^{TRP}×1, so that the joint data 552 has dimensions 2×1. In the example of FIG. 5B, the diagram 550 includes a joint mapping 570 of the data for transmission on the TRPs.

In some aspects, the coherence of CJT refers to a phase coherence between TRPs that may be transmitting a same layer as opposed to NCJT in which each layer is transmitted via a single TRP and phase coherence between the TRPs may not provide additional benefits. In some aspects of wireless communication, CJT may be extended to up to 4 TRPs, for example, in a low frequency band such as FR1, based on a type-II codebook. In some aspects, providing additional TRPs for CJT may effectively increase an antenna size for transmitting the low frequency transmission.

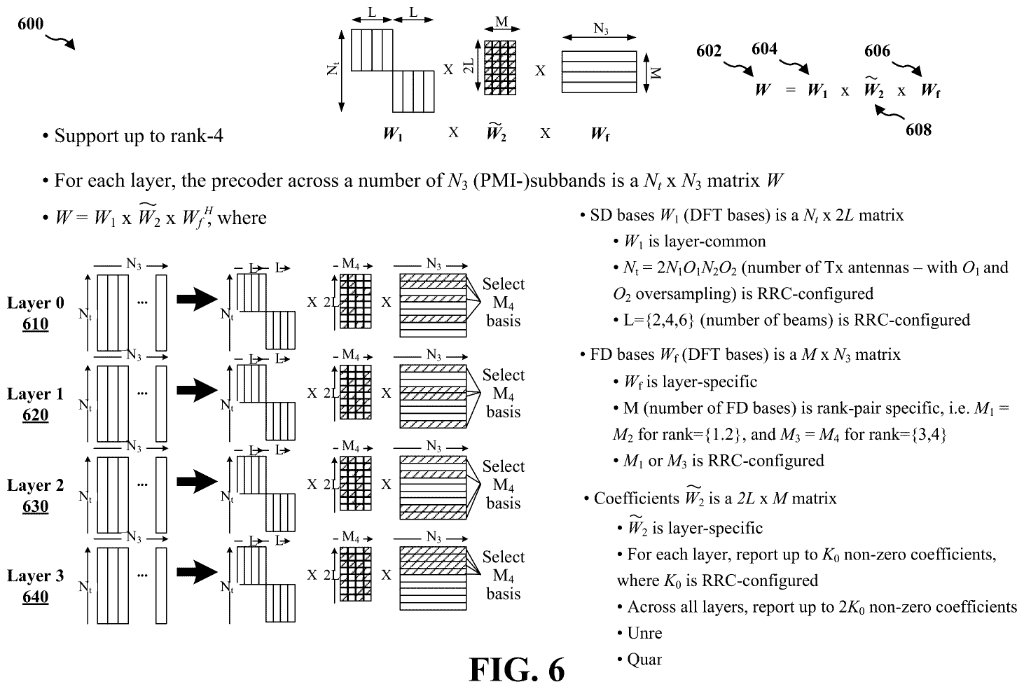

FIG. 6 is a diagram 600 illustrating components of a precoder matrix 602 in some aspects of wireless communication. In the example of FIG. 6, the precoder matrix 602 (“W”) may be generated based on a first matrix 604 (“W₁”), a second matrix 606 (“W_{f}” or “W_{f}^{H}”), and a third matrix 608 (“\tilde{W}₂”). The first matrix 604 may be associated with a spatial domain (SD), the second matrix 606 may be associated with a frequency domain (FD), and the third matrix 608 may be associated with a set of non-zero coefficients (NZCs). In the example of FIG. 6, the precoder matrix 602 may correspond to a precoder for one layer. In the example of FIG. 6, the precoder matrix 602 may be generated for each layer and up to four layers (e.g., support up to rank-4). For example, the precoder matrix 602 may be generated for a first layer 610 (“Layer 0”), a second layer 620 (“Layer 1”), a third layer 630 (“Layer 2”), and a fourth layer 640 (“Layer 3”)

In some aspects, the first matrix 604 (“W₁”) may be a Nₜ×2L matrix, where Nₜ is a value based on a number of transmission antennas and an oversampling and L is a number of beams used for the joint transmission. In some examples, both Nₜ and L may be RRC-configured. In some aspects, the first matrix 604 may be selected from a set of SD basis matrices (e.g., DFT bases) for the spatial domain. The first matrix 604 may be common to layers to be transmitted via a joint transmission, e.g., a NCJT or a CJT. As used herein, the term “SD basis” may also be referred to as a “beam.”

The second matrix 606 (“W_{f}” or “W_{f}^{H}”), in some aspects, may be an M×N₃ matrix, where M may be an RRC-configured number of FD bases (e.g., FD DFT bases), and N₃ is a number of spatial domain bases. In some examples, M may be rank (pair)-specific. For example, M₁=M₂ for rank={1, 2} and M₃=M₄ for rank={3, 4}. In some aspects, the second matrix 606 may be layer-specific such that a second matrix W_{f} or W_{f}^{H} may include a first set of selected FD bases associated with a first layer, where the first set of selected FD bases may or may not overlap, completely or partially, with a set of selected FD bases for a second matrix W_{f} or W_{f}^{H} associated with a second layer.

The third matrix 608 (“\tilde{W}₂”), in some aspects, may be a 2L×M matrix including a set of NZCs. In some aspects, the third matrix 608 is layer-specific and a CSI report may report up to K₀ NZCs for each layer and up to 2K₀ NZCs across all the layers, where unreported coefficients are assumed to be zero, or are set to zero. The coefficients may be quantized based on preconfigured quantized values and/or may be quantized based on RRC-configured quantized values.

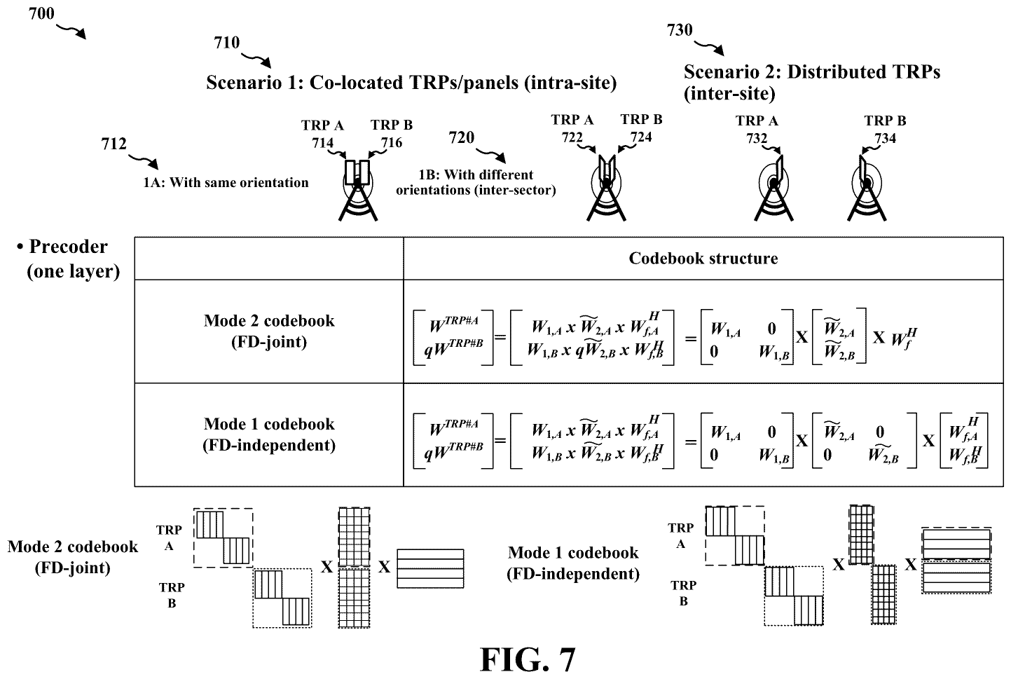

FIG. 7 is a diagram 700 illustrating a set of precoder components (e.g., an SD component W₁, an FD component W_{f} or W_{f}^{H}, and a coefficients component \tilde{W}₂) used in some aspects of CJT, as presented herein. In a first scenario 710, TRPs may be co-located TRPs/panels and may be referred to as “intra-site” TRPs. In a second scenario 730, TRPs may be distributed TRPs and may be referred to as “inter-site” TRPs.

In examples in which the TRPs are intra-site TRPs (e.g., the first scenario 710), the TRPs may have a same spatial orientation (e.g., a first intra-site scenario 712) or may have different spatial orientations (e.g., a second intra-site scenario 720). For example, in the first intra-site scenario 712 (e.g., scenario 1A) associated with a CJT from multiple co-located TRPs (e.g., antennas at a same site) with a same spatial orientation, a same spatial domain matrix W₁ may be associated with (or used for) each TRP (e.g., for a first TRP 714 (“TRP A”) and for a second TRP 716 (“TRP B”). In the second intra-site scenario 720 (e.g., scenario 1B) associated with a CJT for co-located TRPs (e.g., antennas at a same site) with different spatial orientations, different spatial domain matrices W_{1,A} and W_{1,B} may be associated with (or used for) the different TRPs (e.g., a spatial domain matrix W_{1,A} for a third TRP 722 (“TRP A”) and a spatial domain matrix W_{1,B} for a fourth TRP 724 (“TRP B”)).

In examples in which the TRPs are inter-site TRPs (e.g., the second scenario 730), each component (e.g., the SD component W₁, the FD component W_{f} or W_{f}^{H}, and the coefficients component \tilde{W}₂) may be selected independently. For example, different spatial domain matrices W_{1,A} and W_{1,B} may be associated with (or used for) the different TRPs at different sites (e.g., the spatial domain matrix W_{1,A} for a fifth TRP 732 (“TRP A”) and a spatial domain matrix W_{1,B} for a sixth TRP 734 (“TRP B”). Additionally, different frequency domain matrices W_{f,A}^{H} or W_{f,B}^{H} may be associated with (or used for) the different TRPs at different sites (e.g., the spatial domain matrix W_{f,A}^{H} for the fifth TRP 732 and the spatial domain matrix W_{f,B}^{H} for the sixth TRP 734). Finally, each of the fifth TRP 732 and the sixth TRP 734 may further be associated with different third components \tilde{W}_{2,A} and \tilde{W}_{2,B} respectively.

In the illustrated example of FIG. 7, a codebook structure may be based on whether FD component is common for the two TRPs, or independent. In examples in which the FD component is common for the two TRPs, the respective codebook may be referred to as a “Mode 2 codebook,” which may also be referred to as “FD-joint.” In such scenarios, the FD component W_{f} or W_{f}^{H} is the same for TRP A and for TRP B.

In examples in which the FD component is separate or independent for the two TRPs, the respective codebook may be referred to as a “Mode 1 codebook,” which may also be referred to as “FD-independent.” In such scenarios, different FD matrices W_{f,A}^{H} or W_{f,B}^{H} may be associated with (or used for) the different TRPs at different sites (e.g., the spatial domain matrix W_{f,A}^{H} for the fifth TRP 732 and the spatial domain matrix W_{f,B}^{H} for the sixth TRP 734).

Referring again to a Type-II codebook for CJT with multiple TRPs, two different TRP selection and/or determination schemes may be employed, where the value N represents a number of cooperating TRPs assumed in PMI reporting, for example, of a CSI report from the UE to a network entity. In a first alternate, the value N may be configured by the network, for example, by a base station, via higher layer signaling, such as RRC signaling. In such examples, the value of N indicates the number of TRPs (e.g., N=N_{TRP}). In some such examples, the UE may report only one transmission hypothesis in a CSI report.

In a second alternate, the N TRPs may be selected by the UE and reported as part of the CSI report to the network. In some such examples, the N TRPs reported by the UE may be a value between 1 and N_{TRP}, where N refers to the number of selected TRPs, and N_{TRP} refers to the maximum number of cooperating TRPs. In some examples, the value of N_{TRP} may be configured by the network. For example, the network may configure the UE with four TRPs (e.g., TRPs A-D). In some such examples, the UE may select N TRPs, where N is between 1 and 4. In examples in which the UE selects the N TRPs, the UE may also report which of the TRPs are selected. For example, the UE may select two TRPs, and indicate that the UE selected TRP A and TRP C. In some such examples, the UE may report only one transmission hypothesis in a CSI report.

In some examples, the network may configure the UE with a set of parameters for a single TRP communication mode. For example, the network may output a parameter combination configuration, which may be referred to as a “ParamCombination” configuration or by any other name, that configures the UE with a first parameter L, a second parameter p₁, a third parameter p₃, and a fourth parameter β. The parameter combination configuration may be provided to the UE via higher-layer signaling, such as RRC signaling.

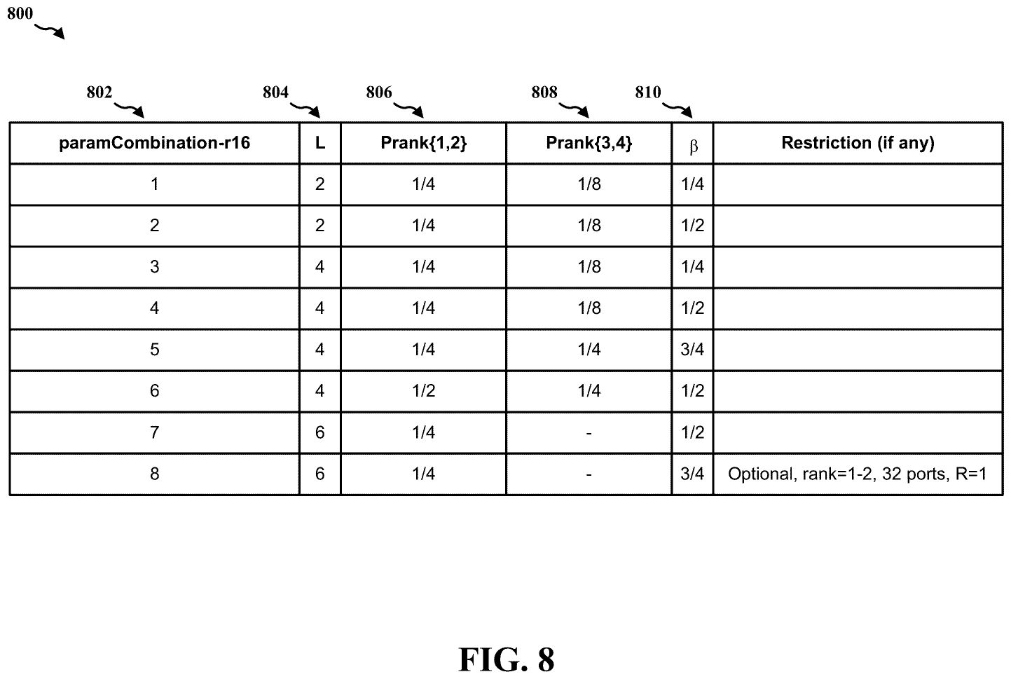

FIG. 8 depicts a table 800 illustrating different combinations of the parameters based on a value of a parameter combination indicator 802, as presented herein. As shown in FIG. 8, the value of the parameter combination indicator 802 may range from 1 to 8, and value of different parameters may be set accordingly. In the example of FIG. 8, the value of the parameter combination indicator 802 sets the value of a first parameter 804 (L), a second parameter 806 (p₁), a third parameter 808 (p₃), and a fourth parameter 810 (β). In the example of FIG. 8, the value of the second parameter 806 may apply for rank 1 and for rank 2, and the value of the third parameter 808 may apply for rank 3 and for rank 4.

In the example of FIG. 8, the value of the first parameter 804 indicates a quantity of beams. As shown in FIG. 8, the value of the first parameter may be 2, 4, 6 beams (e.g., L={2, 4, 6}). In the example of FIG. 8, the value of the second parameter 806 may be either “¼” or “½.” The value of the third parameter 808 may be either “⅛” or “¼.” The value of the fourth parameter 810 may be either “¼,” “½,” or “¾.”

The UE may use the values configured by the parameter combination indicator 802 to determine a quantity of selected SD bases L, a quantity of FD bases M, and a quantity of NZCs per layer in the third matrix (“\tilde{W}₂”) of the precoder. For example, the UE may select the number of SD bases from the indicated by the first parameter 804. For example, when the parameter combination indicator 802 is set to “3,” then the UE may select four SD bases.

The UE may select the number of FD bases M based on a rank. In some examples, the value of M may correspond to a delay associated with a selected path associated with a beam. The UE may use Equation 1 (below) to determine a number of FD bases to select when the rank is 1 or 2.

$${M}_{r a n k \{ 1 , 2 \}} = ⌈ {p}_{r a n k \{ 1 , 2 \}} * \frac{{N}_{3}}{R} ⌉ \qquad Equation 1$$

In Equation 1, the value of the FD bases M is the same for rank 1 and for rank 2 and, thus, Equation 1 may be re-written as Equation 2 (below).

$${M}_{1} = {M}_{2} = ⌈ {p}_{1} * \frac{{N}_{3}}{R} ⌉ \qquad Equation 2$$

The UE may use Equation 3 (below) to determine a number of FD bases to select when the rank is 3 or 4.

$${M}_{r a n k \{ 3 , 4 \}} = ⌈ {p}_{r a n k \{ 3 , 4 \}} * \frac{{N}_{3}}{R} ⌉ \qquad Equation 3$$

In Equation 3, the value of the FD bases M is the same for rank 3 and for rank 4 and, thus, Equation 3 may be re-written as Equation 4 (below).

$${M}_{3} = {M}_{4} = ⌈ {p}_{3} * \frac{{N}_{3}}{R} ⌉ \qquad Equation 4$$

In Equations 1 to 4, the value of the term “p_{rank{1,2}}” and “p₁” may be given by the second parameter 806 of FIG. 8. The value of the term “p_{rank{3,4}}” and “p₃” may be given by the third parameter 808 of FIG. 8. The value of the term “N₃” corresponds to the number of PMI-subbands, and may be determined by a number of CQI subbands, and a number of PMI-subbands per CQI-subbands (e.g., R={1,2}). The number of CQI subbands may be determined by a higher-layer parameter, which may be referred to as a “csi-ReportingBand” parameter, or by any other name. The number of PMI-subbands per CQI-subbands (R) may be configured by a higher-layer parameter, which may be referred to as a “numberOfPMISubbandsPerCQISubband” parameter, or by any other name. In examples in which R is equal to 1, then the total number of PMI subbands N₃, which may correspond to an FD basis length, may be selected from a set of 1 to 19 (e.g., N₃={1, 2, . . . , 19}). In examples in which R is equal to 2, then the total number of PMI subbands may be selected from a set of 1 to 37 (e.g., N₃={1, 2, . . . , 37}). In scenarios in which R is equal to 2, the PMI subband size may be finer than the CQI-subband size (e.g., half the size).

For edge CQI subbands, if the number of RBs is less than or equal to a nominal CQI subband size/2, then the UE may report one PMI. If the number of RBs is greater than the nominal CQI subband size/2, then the UE may report two PMIs. In some examples, for other CQI subbands (e.g., non-edge CQI subbands), the UE may report two PMIs.

The UE may select a number of NZCs per layer and across all layers. The UE may select the number of NZCs per layer so that the selected number is less than or equal to a maximum number of NZCs per layer K₀. Additionally, the UE may select a total number of NZCs across all layers that is less than or equal to 2*K₀. The UE may use Equation 5 (below) to determine the maximum number of NZCs per layer K₀.

$${K}_{0} = ⌈ β \times 2 {LM}_{1} ⌉ \qquad Equation 5$$

Thus, it may be appreciated that, based on the parameter combinations of (L, p₁, p₃, β), and as indicated by the value of the parameter combination indicator 802, the UE may select a number of SD bases, a number of FD bases, and a number of NZCs.

However, the example table of FIG. 8 corresponds to a single TRP communication mode. Thus, it may be beneficial to enable a UE to select a number of SD bases, a number of FD bases, and a number of NZCs when operating in a multiple TRP communication mode. For example, with multiple TRP, the parameter combination may also include a TRP-level parameter that enables the selection of the number of SD bases, the number of FD bases, and the number of NZCs to be indicated on a per-TRP level. For example, there may be, per TRP, a number of selected SD bases (Lₙ) and/or a number of selected FD bases (Mₙ), and where the value of n is between 1 and the N TRPs (e.g., n=(1, . . . , N_{TRP}). As described above, the value of TRPs N may be configured by the network (e.g., alternate 1) or by the UE (e.g., alternate 2).

Additionally, it may be appreciated that the payload size of the CSI report may be impacted based on the number of TRPs that the UE selects. That is, it may be beneficial to support varied numbers of selected SD bases across all TRPs (Lₜₒₜ) due to different numbers of TRPs selected, such as when the number of TRPs selected (N) is less than or equal to the configured number of TRPs (N_{TRP}). For example, the UE may be configured with four TRPs (e.g., N_{TRP}=4), but the UE may select two of the TRPs to include CSI for in the CSI report (e.g., N=2). That is, for a smaller number of selected TRPs, it may be possible that the total number of SD bases across all TRPs (Lₜₒₜ) may be indicated.

For example, in a first example scenario, the value of SD bases across all TRPs (Lₜₒₜ) may be set to six (e.g., Lₜₒₜ=6) with four TRPs and 32 ports, where each TRP has N₁N₂=2 ports per polarization. In such scenarios, if the UE selects a single TRP, then an indication of Lₜₒₜ=6 may be redundant as each TRP is configured with four ports.

In a second example scenario, the value of SD bases across all TRPs (Lₜₒₜ) may be set to four (e.g., Lₜₒₜ=4) with four TRPs and 16 ports, where each TRP has N₁N₂=2 ports per polarization. In such scenarios, an indication of Lₜₒₜ=4 may be redundant when the UE selects a single TRP or selects two TRPs.

As described above, in some aspects of wireless communication, a CSI report may be divided into two parts (e.g., a CSI part 1 and a CSI part 2). For example, having multiple CSI parts may allow for larger CSI payload sizes. In some aspects, the CSI part 1 may have a fixed payload size and may have a smaller payload size than the CSI part 2. In some aspects, the CSI part 1 may include more significant (important) information than the CSI part 2 and may, therefore, be transmitted in a manner to achieve a higher reliability for reception of the CSI part 1. As an example, the CSI part 1 may include rank indicator (RI) information and channel quality indicator (CQI) information. The CSI part 2 may have a variable payload size and the CSI part 1 may also include information used to determine a payload size of the CSI part 2. In some aspects, the CSI part 1 may include non-zero coefficients (NZCs) that help to enable a receiver of the CSI report to determine the payload size of the CSI part.

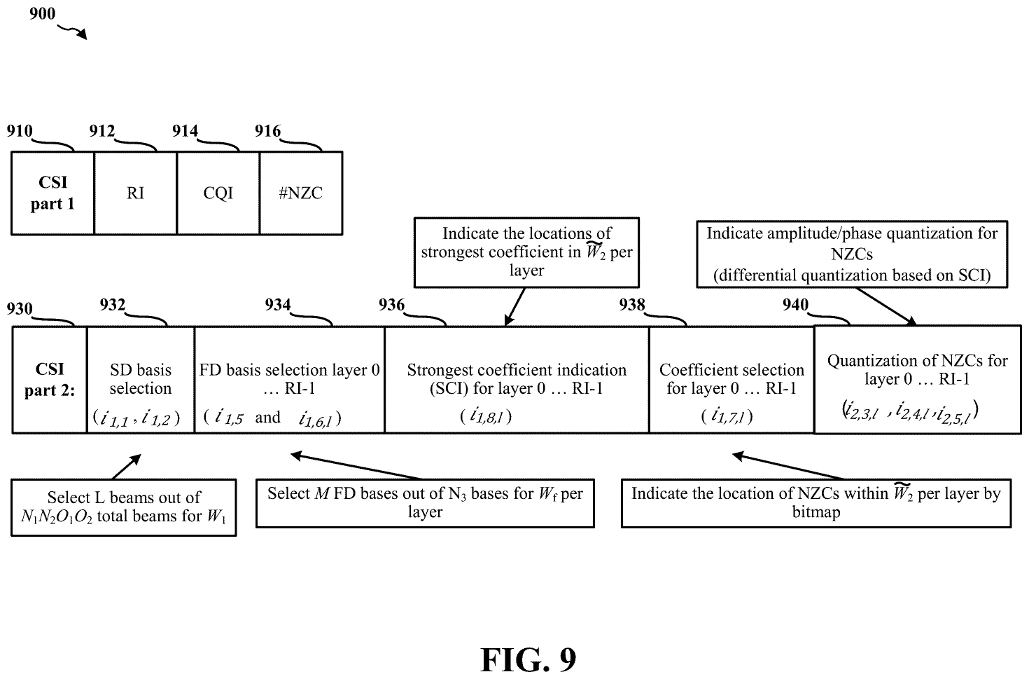

FIG. 9 is a diagram 900 illustrating an example of a two part CSI, as presented herein. In the illustrated example of FIG. 9, the diagram 900 illustrates a first CSI part 910 (e.g., a CSI part 1) and a second CSI part 930 (e.g., a CSI part 2). In the example of FIG. 9, the first CSI part 910 includes an RI field 912, a CQI field 914, and a number of NZCs field 916. The RI field 912 may indicate a number of layers associated with the corresponding transmission. The CQI field 914 may indicate CQI information associated with the corresponding transmission. The number of NZCs field 916 may indicate NZCs information associated with the corresponding transmission. For example, the NZCs field 916 may indicate a total number of NZCs across all layers, K_{NZ}^{tot}. The NZCs field 916 may have a bit width of log₂ 2K₀ bits, where the value of “K₀” may be determined by a parameter combination indicator and Equation 5 (above). In some examples, both the RI field 912 and the number of NZCs field 916 may be used to determine a payload size of the second CSI part 930.

In the example of FIG. 9, the second CSI part 930 includes an SD basis selection field 932 and an FD basis selection field 934. The SD basis selection field 932 may indicate a selection of L beams out of N₁N₂O₁O₂ total beams for the SD component W₁ of the precoder W. The FD basis selection field 934 may indicate a selection of M FD bases out of N₃ bases for the FD component W_{f} or W_{f}^{H} of the precoder W. The selection of the M FD bases may be for each layer. For example, the RI field 912 of the first CSI part 910 may indicate that there are RI layers and, thus, the FD basis selection field 934 may indicate M FD bases for layer 0 to layer RI−1.

The bit width for a beam group (i_{1,1}) component of the SD basis selection field 932 may be log₂ O₁O₂ bits. The bit width for a beam indication (i_{1,2}) component of the SD basis selection field 932 may be

$$⌈ {log}_{2} ( \begin{matrix}{N}_{1} {N}_{2} \\ L\end{matrix} ) ⌉$$

bits. The bit width of the FD basis selection field 934 may depend on the value of the total number of PMI subbands N₃. For example, when the total number of PMI subbands N₃ is less than or equal to 19, then the UE may report the (i_{1,6,1}) component, where L=0, . . . , RI−1 and using

$$⌈ {log}_{2} ( \begin{matrix}{N}_{3} \\ {M}_{RI}\end{matrix} ) ⌉ \times RI$$

bits. In examples in which the total number of PMI subbands N₃ is greater than 19, the UE may use a window-based two-stage selection.

In some examples, the second CSI part 930 may include indications of parameters associated with the NZCs indicated in the number of NZCs field 916 of the first CSI part 910. For example, the second CSI part 930 may include a strongest coefficient indication field 936 for each of the layers 0 to RI−1, a coefficient selection indication field 938 for each of the layers 0 to RI−1, and a quantization of NZCs indication field 940 for each of the layers 0 to RI−1. The strongest coefficient indication field 936 may indicate the location(s) of the strongest coefficients of the third matrix W₂ of the precoder W. The coefficient selection indication field 938 may indicate the location of the NZCs within the third matrix W₂ for each of the layers 0 to RI−1 (e.g., using a bitmap per layer). The quantization of NZCs indication field 940 may indicate an amplitude and/or phase quantization for NZCs in each layer (e.g., based on the strongest coefficient indication indicated by the strongest coefficient indication field 936 for the corresponding layer).

The bit width for the strongest coefficient indication (SCI) of the strongest coefficient indication field 936 may be ┌log₂(K_{NZ}^{tot})┐ bits when RI is one. The bit width for the SCI of the strongest coefficient indication field 936 may be ┌log₂ 2L┐×RI bits when RI is more than one. The bit width of the coefficient selection indication field 938 may be RI size-2 LM bitmaps, with a total of 2LM×RI bits.

The bit width for a (i_{2,3,l}) component of the NZCs indication field 940 may be 4-bits, with a reference amplitude weaker polarization. The bit width for a (i_{2,4,1}) component of the NZCs indication field 940 may be (K_{NZ}^{tot}−RI)×3 bits, based on a differential amplitude for each coefficient other than the strongest coefficient. The bit width for a (i_{2,5,l}) component of the NZCs indication field 940 may be (K_{NZ}^{tot}−RI)×4 bits, based on a phase for each coefficient other than the strongest coefficient.

It may be appreciated that the order of the fields of the first CSI part 910 and/or the second CSI part 930 may be different in other examples. Additionally, or alternatively, the first CSI part 910 and/or the second CSI part 930 may include additional or alternate fields in other examples.

In some aspects of the disclosure, additional information for a CJT is provided in one or more of CSI part 1 or CSI part 2.

In some aspects of wireless communication, a CSI indicating TRP selection for CJT may be associated with an enhanced Type II (eType-II) codebook. While a fixed payload size may be associated with a first part of the CSI, a payload size of the second part of the CSI may be variable and may depend (or be based on) a number of selected TRPs. The variable payload size for the second part of the CSI may be based on one or more of (1) different sizes of the first matrix W₁ for SD basis selection indication (e.g., via the SD basis selection field 932), (2) different sizes of the second matrix W_{f} for FD basis selection indication (e.g., via the indication of the FD basis selection field 934), and/or (3) different sizes for the strongest coefficient indication field 936, the coefficient selection indication field 938, and/or the quantization of NZCs indication field 940 associated with the third matrix \tilde{W}₂.

In examples in which a UE and a network entity are communicating via CJT with multiple TRPs (“mTRP”), the CSI report may indicate TRP selection (and the associated precoder, for example, using the eType-II codebook) of N TRPs, where N is the number of cooperating TRPs assumed in PMI reporting.

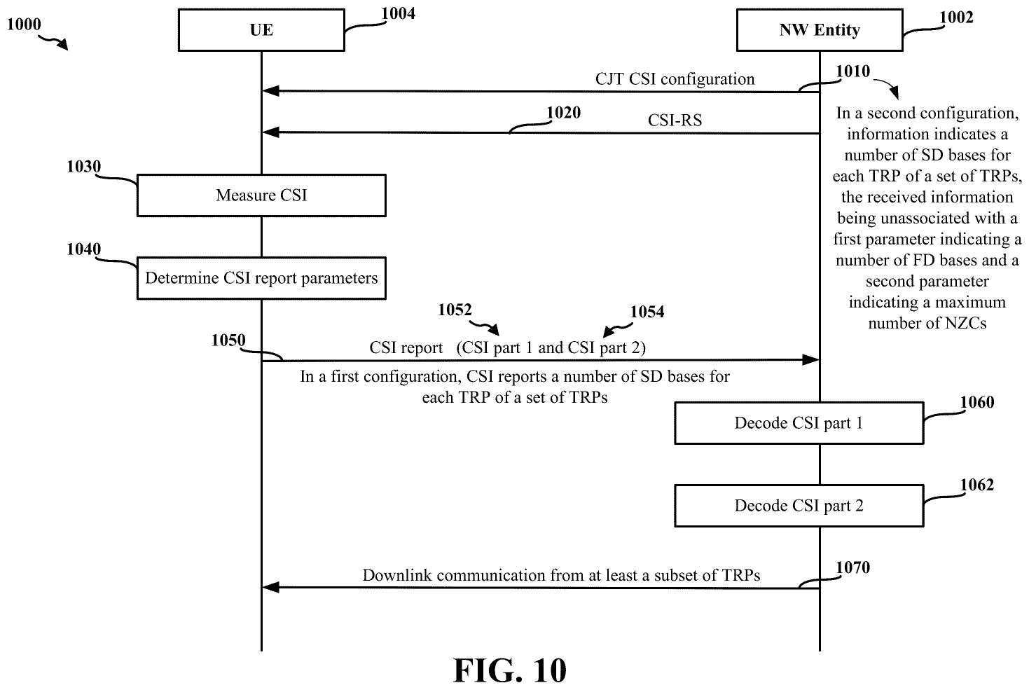

FIG. 10 illustrates an example communication flow 1000 between a network entity 1002 and a UE 1004, as presented herein. One or more aspects described for the network entity 1002 may be performed by a component of a base station or a component of a base station, such as a CU, a DU, and/or an RU. Aspects of the network entity 1002 may be implemented by the base station 102 of FIG. 1 and/or the base station 310 of FIG. 3. Aspects of the UE 1004 may be implemented by the UE 104 of FIG. 1 and/or the UE 350 of FIG. 3. Although not shown in the illustrated example of FIG. 10, in other examples, the network entity 1002 and/or the UE 1004 may be in communication with one or more other base stations or UEs.

In the example of FIG. 10, the network entity 1002 and the UE 1004 may each be of multiple TRPs and have the capability of CJT. In the illustrated example, the communication flow 1000 facilitates the UE 1004 using a TRP-level parameter of the parameter combination configuration to select, at least, a number of SD bases.

As shown in FIG. 10, the network entity 1002 may transmit a CJT CSI configuration 1010 that is received by the UE 1004. The CJT CSI configuration 1010 may configure the UE 1004 to use one or more parameters when transmitting a CSI report. In some examples, the CJT CSI configuration 1010 may include a parameter configuration indication that configures one or more parameters. In some examples, the CJT CSI configuration 1010 may indicate a number of TRPs and/or indicate certain TRPs. In some examples, the CJT CSI configuration 1010 may configure the UE 1004 to select a number of TRPs and/or to select one or more TRPS of a set of TRPs. In some examples, the CJT CSI configuration 1010 may indicate a total number of SD bases across all TRPs. In some examples, the CJT CSI configuration 1010 may indicate a number of SD bases for respective TRPs.

The network entity 1002 may transmit one or more CSI-RS 1020 that are received by the UE 1004. At 1030, the UE 1004 may perform measurements on the CSI-RS 1020. At 1040, the UE 1004 may determine a set of parameters for a CSI report 1050. The set of parameters for the CSI report 1050 may be based on the CJT CSI configuration 1010 and the values of the set of parameters may be based on the measurements on the CSI-RS 1020.

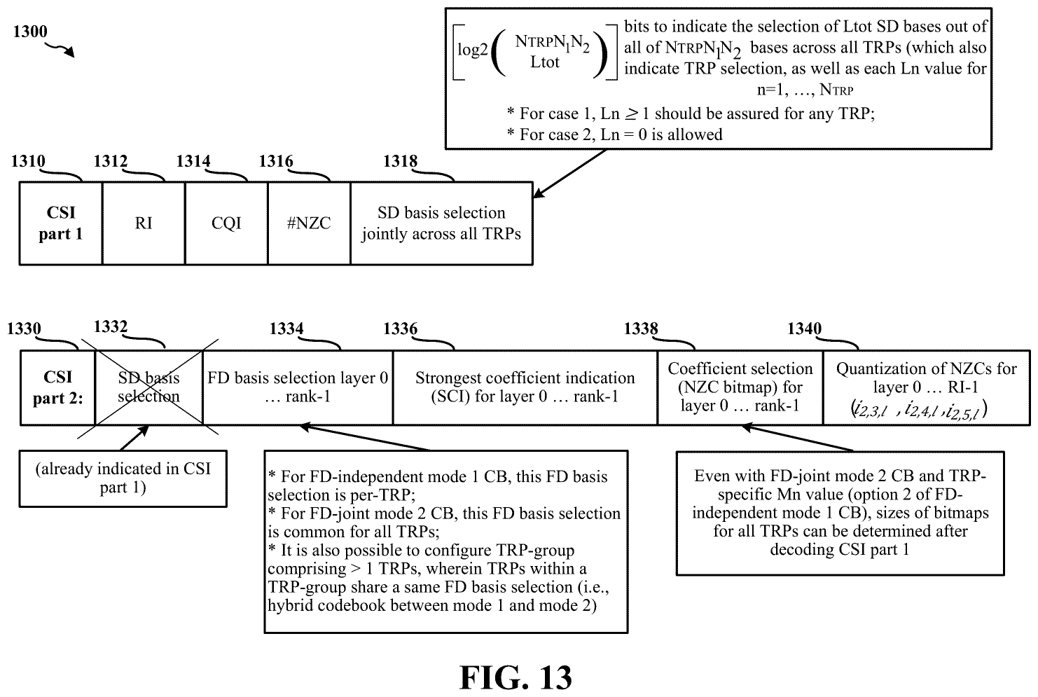

As shown in FIG. 10, the UE 1004 may transmit the CSI report 1050 that is received by the network entity 1002. The CSI report 1050 may be populated with values determined by the UE 1004 (e.g., at 1040). In the example of FIG. 10, the CSI report 1050 includes a first CSI part 1052 (“CSI part 1”) and a second CSI part 1054 (“CSI part 2”). The first CSI part 1052 may have a fixed payload size and the second CSI part 1054 may have a variable payload size indicated by the first CSI part 1052. As described in connection with FIGS. 13 to 16 and 18, at least one of the first CSI part 1052 or the second CSI part 1054 may indicate a number of SD basis for each TRP of a set of TRPs for a CJT of data (e.g., downlink communication 1070).

At 1060, the network entity 1002 may decode the first CSI part 1052 of the CSI report 1050. At 1062, the network entity 1002 may decode the second CSI part 1054 of the CSI report 1050. The network entity 1002 may use aspects of the first CSI part 1052 to determine the payload size of the second CSI part 1054. Based on the first CSI part 1052 and/or the second CSI part 1054, the network entity 1002 may output a downlink communication 1070 from at least a subset of TRPs that is received by the UE 1004.

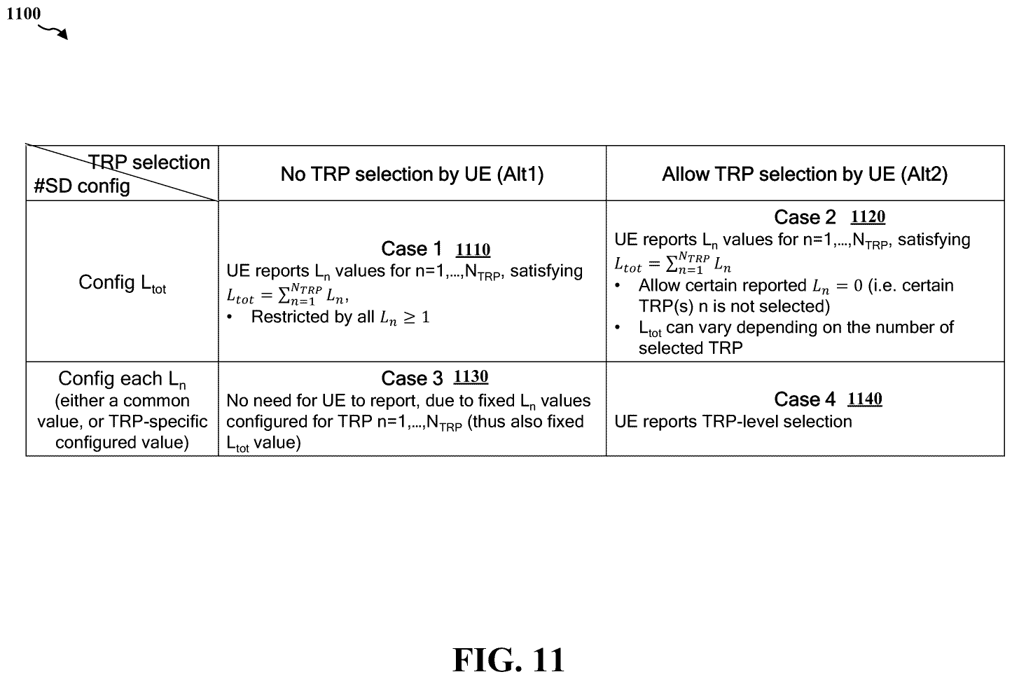

In a first configuration, the UE 1004 may include an indication of the number of SD bases for each TRP of a set of TRPs with the CSI report 1050. In some examples, the UE 1004 may include the indication of the number of SD bases for each TRP in the first CSI part 1052. In other examples, the UE 1004 may include the indication of the of number of SD bases for each TRP in the second CSI part 1054. Aspects of the first configuration are described in connection with FIGS. 11 to 16.

In a second configuration, the CJT CSI configuration 1010 may include information that indicates a number of SD bases for each TRP of a set of TRPs. The information may be unassociated with a first parameter indicating a number of FD bases and a second parameter indicating a maximum number of NZCs. Aspects of the second configuration are described in connection with FIGS. 11, 17, and 18.

FIG. 11 depicts a table 1100 illustrating difference cases based on TRP selection and number of SD bases configuration. For example, TRP selection may be performed by the network (e.g., alternate 1) in which the UE does not select the TRPs, or TRP selection may be performed by the UE (e.g., alternate 2). Additionally, the number of SD bases configuration may be for the total number of SD bases across all layers (Lₜₒₜ), or may be for each layer (Lₙ). In examples in which the number of SD bases is for each layer (Lₙ), the configuration may be either a common value (e.g., a value that is the same for each layer). In other examples, the number of SD bases for each layer (Lₙ) may be a TRP-specific configured value. For example, the configuration of the number of SD bases may include different values for each TRP.

As shown in FIG. 11, based on the TRP selection and the number of SD bases configuration, four example cases may be available. In a first case 1110 (“Case 1”), the network selects the number of TRPs and configures the number of SD bases across all layers (Lₜₒₜ). In such examples, the UE reports the number of SD bases for each TRP (e.g., the UE reports Lₙ values for n=1, . . . . N_{TRP}). In the example of the first case 1110, the reported values may be configured to satisfy Equation 6 (below).

$${L}_{tot} = {\sum }_{n = 1}^{{N}_{T R P}} {L}_{n} , where {L}_{n} \geq 1 \qquad Equation 6$$

That is, the UE may report the number of selected SD bases for each TRP (Lₙ), where each TRP has at least one selected SD bases, and the sum of the SD bases selected for each of the TRPs should equal the value of the number of SD bases across all layers (Lₜₒₜ).

In a second case 1120 (“Case 2”), the UE selects the number of TRPs, and the network configures the number of SD bases across all layers (Lₜₒₜ). In such examples, the UE reports the number of SD bases for each TRP (e.g., the UE reports Lₙ values for n=1, . . . . N_{TRP}). In the example of the second case 1120, the reported values may be configured to satisfy Equation 7 (below).

$${L}_{tot} = {\sum }_{n = 1}^{{N}_{TRP}} {L}_{n} \qquad Equation 7$$

Similar to the example of the first case 1110, the UE may report the number of selected SD bases for each TRP (Lₙ). However, the UE may determine not to select certain of the TRPs and, thus, the non-selected TRPs may have a value of selected SD bases being set to zero. In such scenarios, the total number of selected SD bases across all layers may vary based on the number of TRPs that the UE selects. That is, in a scenario where the network configures the value of SD bases across all TRPs (Lₜₒₜ) to be six (e.g., Lₜₒₜ=6) with four TRPs and 32 ports, where each TRP has N₁N₂=2 ports per polarization, but the UE selects a single TRP, then the total number of selected SD bases by the UE may be less than the total number of SD bases across all layers (Lₜₒₜ) that is configured by the network.

In a third case 1130 (“Case 3”), the network selects the TRPs for use by the UE, and the network configures the number of SD bases for each TRP Lₙ. In such scenarios, the UE may skip reporting the number of SD bases for each TRP as the number of SD bases is configured by the network and the TRPs are also selected by the network. That is, there is a fixed number of SD bases for each TRP, and a fixed number of TRPs, which results in a fixed number of total number of SD bases across all layers (Lₜₒₜ).

In a fourth case 1140 (“Case 4”), the UE selects the TRPs for use by the UE, and the network configures the number of SD bases for each TRP Lₙ. In such scenarios, the UE may report which SD bases the UE selects for each TRP.

In the example of FIG. 11, it may be up to the UE to select the TRPs, for example, based on the measurements performed by the UE, as described in connection with 1030 of FIG. 10. In the example of the fourth case 1140, the UE may select the TRPs based on reference signal received power (RSRP) of CSI-RS resources for each TRP, respectively. In the example of the second case 1120, the UE may select the TRPs based on either RSRP, or additionally depending on the SD-projected power, for example, an SD basis selection for the first matrix (“W₁”) of a precoder

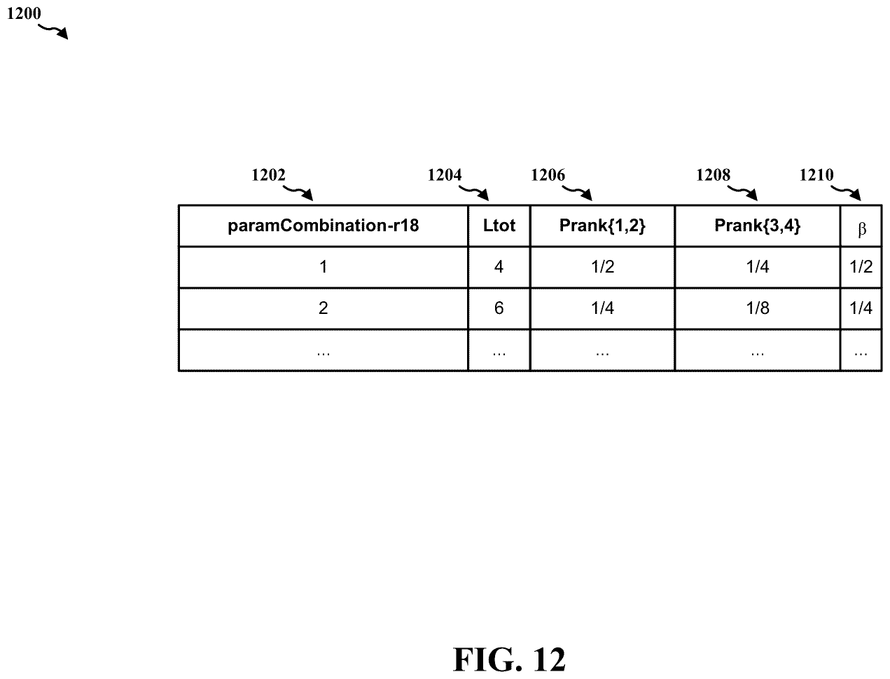

FIG. 12 depicts a portion of a table 1200 illustrating different combinations of the parameters based on a value of a parameter combination indicator 1202, as presented herein. In the example of FIG. 12, the parameter combination indicator 1202 facilitates configuring the parameters of a CSI report at a UE when employing multiple TRP communication.

In the example of FIG. 12, the value of the parameter combination indicator 1202 may set the value of a first parameter 1204 (Lₜₒₜ), a second parameter 1206 (p₁), a third parameter 1208 (p₃), and a fourth parameter 1210 (β). In the example of FIG. 12, and similar to the example of FIG. 8, the value of the second parameter 1206 may apply for rank 1 and for rank 2, and the value of the third parameter 1208 may apply for rank 3 and for rank 4.

In the example of FIG. 12, the value of the first parameter 1204 indicates a quantity of SD bases across all layers. As shown in FIG. 12, the quantity of SD bases across all layers starts at four beams.

In the example of FIG. 12, the second parameter 1206 and the third parameter 1208 may be referred to as a first scaling factor that may facilitate determining the number of selected FD bases (M). Similar to the example of FIG. 8, the UE may use the value of the second parameter 1206 when the rank is 1 or 2, and may use the value of the third parameter 1208 when the rank is 3 or 4. In some examples, the first scaling factor may be rank (pair)-specific. Additionally, the UE may use the fourth parameter 1210 (e.g., a second scaling factor) to facilitate determining the maximum number of NZCs (K₀).

In some examples, when the UE is determining the number of selected FD bases (M) and the maximum number of NZCs (K₀), the UE may apply different techniques based on whether the UE is employing an FD-joint codebook (e.g., the mode 2 codebook of FIG. 7) or an FD-independent codebook (e.g., the mode 1 codebook of FIG. 7).

In examples in which the UE is employing an FD-joint codebook, the total number of selected FD bases (M) may be rank (pair)-specific and may be irrelevant to the number of TRPs (e.g., either N_{TRP} configured by the network or N selected by the UE). In some such examples, to determine the number of FD bases to select, the UE may use Equation 8a (below) when the rank is 1 or 2, and may use Equation 8b (below) when the rank is 3 or 4.

$${M}_{tot , rank \{ 1 , 2 \}} = ⌈ {p}_{rank \{ 1 , 2 \}} * \frac{{N}_{3}}{R} ⌉ \qquad Equation 8 a$$

$${M}_{tot , rank \{ 3 , 4 \}} = ⌈ {p}_{rank \{ 3 , 4 \}} * \frac{{N}_{3}}{R} ⌉ \qquad Equation 8 b$$

In examples in which the UE is employing an FD-independent codebook, the number of selected FD bases per TRP may be common, which may be referred to as “TRP-common” or “option 1” herein, or may be TRP-specific, which may be referred to as “TRP-specific” or “option 2” herein. In examples in which the number of selected FD bases per TRP is common (e.g., the TRP-common option), the Mₙ value may be rank (pair)-specific and may be determined by the number of TRPs (e.g., either N_{TRP} configured by the network or N selected by the UE). Additionally, to determine the number of FD bases to select for the first case 1110 of FIG. 11, the UE may use Equation 9a (below) when the rank is 1 or 2 and may use Equation 9b (below) when the rank is 3 or 4.

$${M}_{n , rank \{ 1 , 2 \}} = ⌈ {p}_{rank \{ 1 , 2 \}} * \frac{{N}_{3}}{R * {N}_{TRP}} ⌉ \qquad Equation 9 a$$

$${M}_{n , rank \{ 3 , 4 \}} = ⌈ {p}_{rank \{ 3 , 4 \}} * \frac{{N}_{3}}{R * {N}_{TRP}} ⌉ \qquad Equation 9 b$$

With respect to the second case 1120 of FIG. 11, the UE may use Equation 10a (below) to determine the number of selected FD bases when the rank 1 is or 2, and may use Equation 10b (below) when the rank is 3 or 4. In the examples of Equation 10a and 10b, the actual number of selected TRPs (N) may be less than or equal to the configured number of TRPs (N_{TRP}).

$${M}_{n , rank \{ 1 , 2 \}} = ⌈ {p}_{rank \{ 1 , 2 \}} * \frac{{N}_{3}}{R * N} ⌉ \qquad Equation 10 a$$

$${M}_{n , rank \{ 3 , 4 \}} = ⌈ {p}_{rank \{ 3 , 4 \}} * \frac{{N}_{3}}{R * N} ⌉ \qquad Equation 10 b$$

$${M}_{n , rank \{ 1 , 2 \}} = ⌈ {p}_{rank \{ 1 , 2 \}} * \frac{{N}_{3}}{R} ⌉ \qquad Equation 11 a$$

$${M}_{n , rank \{ 3 , 4 \}} = ⌈ {p}_{rank \{ 3 , 4 \}} * \frac{{N}_{3}}{R} ⌉ \qquad Equation 11 b$$

In other examples, the UE may use Equation 11a (below) to determine the number of selected FD bases when the rank is 1 or 2, and may use Equation 11b (below) when the rank is 3 or 4.

It may be appreciated that Equation 11a and Equation 11b are similar to Equation 1 (above) and Equation 3 (above), respectively. In some examples, Equation 11a and Equation 11b may be used for the first case 1110 and/or the second case 1120.

In examples in which the number of selected FD bases per TRP is TRP-specific (e.g., the TRP-specific option), the Mₙ value may be rank (pair)-specific and may be proportional to the number of selected SD bases for the respective TRP (Lₙ). Additionally, to determine the number of FD bases to select for the TRP-specific option, the UE may use Equation 12a (below) when the rank is 1 or 2, and may use Equation 12b (below) when the rank is 3 or 4.

$${M}_{n , rank \{ 1 , 2 \}} = ⌈ {p}_{rank \{ 1 , 2 \}} * \frac{{N}_{3}}{R} * \frac{{L}_{n}}{{L}_{tot}} ⌉ \qquad Equation 12 a$$

$${M}_{n , rank \{ 3 , 4 \}} = ⌈ {p}_{rank \{ 3 , 4 \}} * \frac{{N}_{3}}{R} * \frac{{L}_{n}}{{L}_{tot}} ⌉ \qquad Equation 12 b$$

As shown in Equation 12a and Equation 12b, the number of selected FD bases for an nth TRP is proportional to the number of selected SD bases for the nth TRP (Lₙ) over the total number of selected SD bases across all TRPs (Lₜₒₜ). Equation 12a and Equation 12b may be used in the first case 1110 of FIG. 11 and the second case 1120 of FIG. 11.

When determining the maximum number of NZCs (K₀), the UE may determine the maximum number of NZCs (K₀) for the FD-joint codebook (e.g., the mode 2 codebook of FIG. 7) using the fourth parameter 1210 of FIG. 12, the total number of selected SD bases across all layers (Lₜₒₜ), and the rank {1,2}-associated M value (Mₜₒₜ). For example, the UE may use Equation 13 (below) to determine the maximum number of NZCs (K₀).

$${K}_{0} = ⌈ β * 2 {L}_{tot} {M}_{tot} , rank \{ 1 , 2 \} ⌉ \qquad Equation 13$$

Similar to the FD-joint codebook scenario, when the UE is employing option 1 (e.g., the TRP-common option) of the FD-independent codebook (e.g., the mode 1 codebook of FIG. 7), the UE may determine the maximum number of NZCs (K₀) using the fourth parameter 1210 of FIG. 12, the total number of selected SD bases across all layers (Lₜₒₜ), and the rank {1,2}-associated M value (Mₙ). For example, the UE may use Equation 14 (below) to determine the maximum number of NZCs (K₀).

$${K}_{0} = ⌈ β * 2 {L}_{tot} {M}_{n} , rank \{ 1 , 2 \} ⌉ \qquad Equation 14$$

In scenarios in which the UE is employing the FD-independent codebook and employing option 2 (e.g., the TRP-specific option), the UE may determine the maximum number of NZCs (K₀) based on the fourth parameter 1210 of FIG. 12 and a summation, over n=1, . . . , N_{TRP}, of the number of selected SD bases (Lₙ) multiplied by the rank {1,2}-associated number of selected FD bases (Mₙ) for the first case 1110 of FIG. 11. For example, the UE may use Equation 15 (below) to determine the maximum number of NZCs (K₀) when the network selects the TRPs and configures the total number of selected SD bases across all layers (Lₜₒₜ).

$${K}_{0} = ⌈ β * {\sum }_{n = 1}^{{N}_{TRP}} 2 {L}_{n} {M}_{n , rank \{ 1 , 2 \}} ⌉ \qquad Equation 15$$

Additionally, the UE may use Equation 16 (below) to determine the maximum number of NZCs (K₀) when the UE selects the TRPs and the network configures the total number of selected SD bases across all layers (Lₜₒₜ), as described in connection with the second case 1120 of FIG. 11.

$${K}_{0} = ⌈ β * {\sum }_{n = 1}^{N} 2 {L}_{n} {M}_{n , rank \{ 1 , 2 \}} ⌉ \qquad Equation 16$$

In the examples of Equation 15 and Equation 16, the determining of the maximum number of NZCs (K₀) is similar, except that in Equation 15, the summation is over the network configured number of TRPs (N_{TRP}) and in Equation 16, the summation is over the UE selected number of TRPs (N).

In some examples, the value of the total actual number of selected SD bases (L_{tot,actual}) may be different than the configured value of the total number of selected SD bases (Lₜₒₜ). For example, in the second case 1120 of FIG. 11 in which the UE selects the TRPs, but the network configures the total number of selected SD bases (Lₜₒₜ), the UE may select the beams based on RSRP. In some such examples, the number of beams that the UE selects may be less than the configured total of selected SD bases, for example, when the UE selects those beams with an RSRP that satisfies a threshold. For example, the UE may perform measurements on different beams across a set of TRPs and may select a subset of the beams based on which of the beams has an RSRP that satisfies a threshold. In such examples, the UE may report the number of beams included in the subset of the beams (L_{tot,actual}), which may be less than the configured value of the total number of selected SD bases (Lₜₒₜ).

In some examples, the value of the total actual number of selected SD bases (L_{tot,actual}) may depend on the number of selected TRPs (N) being no larger than a threshold, such as 1 TRP or 2 TRPs. For example, if the UE selects 1 TRP, then the UE may use Equation 17 (below) to determine the total actual number of selected SD bases (L_{tot,actual}).

$${L}_{tot , actual} = min ( {L}_{tot} , {N}_{1} , {N}_{2} ) \qquad Equation 17$$

That is, if the UE selects a single TRP (e.g., N=1), then the total actual number of SD bases (Lₜₒₜ, actual) that the UE reports is the smallest value of configured value of the total number of selected SD bases (Lₜₒₜ), the number of antenna elements in a first direction (N₁), or the number of antenna elements in a second direction (N₂).

In Equations 8a, 8b, 9a, 9b, 10a, 10b, 11a, 11b, 12a, 12b, 13, 14, 15, 16, and 17, the value of the term “p_{rank{1,2}}” may be given by the second parameter 1206 of FIG. 12. The value of the term “p_{rank{3,4}}” may be given by the third parameter 1208 of FIG. 12. The value of the term “N₃” corresponds to the number of PMI-subbands, and may be determined by a number of CQI subbands, and a number of PMI-subbands per CQI-subbands (e.g., R={1,2}). The number of CQI subbands may be determined by a higher-layer parameter, which may be referred to as a “csi-ReportingBand” parameter, or by any other name. The number of PMI-subbands per CQI-subbands (R) may be configured by a higher-layer parameter, which may be referred to as a “numberOfPMISubbandsPerCQISubband” parameter, or by any other name.

In some examples in which the network configures the total number of SD bases (Lₜₒₜ) (e.g., the first case 1110 and the second case 1120 of FIG. 11), the UE may be configured with the ability to determine whether the UE can select the TRPs (e.g., the second case 1120 of FIG. 11). For example, the UE may have the ability to determine to select the TRPs based on the value of the configured total number of SD bases (Lₜₒₜ) and/or the configured number of TRPs (N_{TRP}). In some examples, the UE may determine to select the TRPs when the configured total number of SD bases (Lₜₒₜ) is less than or equal to a SD bases threshold (Lₜₕᵣ) (e.g., Lₜₒₜ≤Lₜₕᵣ). For example, if the SD bases threshold is set to four (e.g., Lₜₕᵣ=4), then the UE may determine to select the TRPs, even if the network provides a selection of TRPs, when the configured total number of SD bases (Lₜₒₜ) is less than or equal to four SD bases. In some such scenarios, the UE may proceed using the conditions of the second case 1120 of FIG. 11.

Additionally, or alternatively, the UE may determine it has the ability to select the TRPs, even if the network provides a selectin of TRPs, when the configured number of TRPs (N_{TRP}) is greater than or equal to a number of TRPs threshold (Nₜₕᵣ) (e.g., N_{TRP}≥Nₜₕᵣ). For example, if the number of TRPs threshold is set to three (e.g., Nₜₕᵣ=3), then the UE may determine to select the TRPs when the configured number of TRPs (N_{TRP}) is greater than or equal to three TRPs. In some such scenarios, the UE may proceed using the conditions of the second case 1120 of FIG. 11.

FIG. 13 is a diagram illustrating an example CSI report 1300 including a first CSI part 1310 (“CSI part 1”) and a second CSI part 1330 (“CSI part 2”), as presented herein. The configuration of the CSI report 1300 may be configured via a CJT CSI configuration, such as the CJT CSI configuration 1010 of FIG. 10. In the example of FIG. 13, the CSI report 1300 includes one or more parameters (or fields) that facilitate indicating a number of SD bases. In the example of FIG. 13, the indication may indicate the SD bases selection jointly across all TRPs in the first CSI part 1310.

In the illustrated example of FIG. 13, the first CSI part 1310 may be similar to the first CSI part 910 of FIG. 9. For example, the first CSI part 1310 of FIG. 13 includes an RI field 1312, a CQI field 1314, and a number of NZCs field 1316.

The first CSI part 1310 also includes an SD basis selection field 1318. The SD basis selection field 1318 may indicate the SD basis selection jointly across all TRPs. It may be appreciated that by indicating the selected SD bases, the SD basis selection field 1318 may also indicate the selected TRPs. The SD basis selection field 1318 may indicate the selection of SD bases (Lₜₒₜ) out of all N_{TRP}N₁N₂ beams. In the first case 1110 of FIG. 11 in which the network selects the TRPs and configures the total number of selected SD bases (Lₜₒₜ), the UE may be configured to select at least one SD bases for each of the selected TRPs (e.g., Lₙ≥1). In the second case 1120 of FIG. 11 in which the UE selects the TRPs, the UE may be configured to select zero SD bases for any of the selected TRPs (e.g., Lₙ=0 is allowed).

The size (e.g., bit width) of the SD basis selection field 1318 may be based on the configured number of TRPs (N_{TRP}) and a number of beams for each TRP (N₁N₂). For example, the size of the SD basis selection field 1318 may be

$$⌈ {log}_{2} ( \begin{matrix}{N}_{TRP} {N}_{1} {N}_{2} \\ {L}_{tot}\end{matrix} ) ⌉$$

bits.

In the illustrated example of FIG. 13, the second CSI part 1330 may be similar to the second CSI part 930 of FIG. 9. For example, the second CSI part 1330 of FIG. 13 includes an FD basis selection field 1334, strongest coefficient indication field 1336, a coefficient selection indication field 1338, and a NZCs indication field 1340. The FD basis selection field 1334 may indicate the selected FD bases. In examples in which the UE is employing the FD-independent codebook (e.g., the mode 1 codebook of FIG. 7), the FD basis selection indicated by the FD basis selection field 1334 may be per-TRP. In examples in which the UE is employing the FD-joint codebook (e.g., the mode 2 codebook of FIG. 7), the FD basis selection indicated by the FD basis selection field 1334 may be common for all TRPs. In some examples, it may be possible to configure a TRP-group including more than one TRP, where TRPs within the TRP-group share a same FD basis selection, such as a hybrid codebook between mode 1 and mode 2).

In the illustrated example of FIG. 13, the sizes of the bitmaps of all TRPs, which may be associated with the coefficient selection indication field 1338 of the second CSI part 1330, may be determined after decoding the first CSI part 1310. Additionally, the sizes of the bitmaps may be determined when the UE is employing the FD-joint codebook (e.g., the mode 2 codebook of FIG. 7) and the TRP-specific number of selected FD basis (Mₙ) (e.g., the option 2 of the FD-independent codebook of FIG. 7).

As shown in FIG. 13, the second CSI part 1330 of the CSI report 1300 may exclude an SD basis selection field 1332, such as the SD basis selection field 932 of the second CSI part 930 of FIG. 9. That is, since the first CSI part 1310 includes the SD basis selection field 1318, the UE may skip providing an indication of the selected beams in the second CSI part 1330.

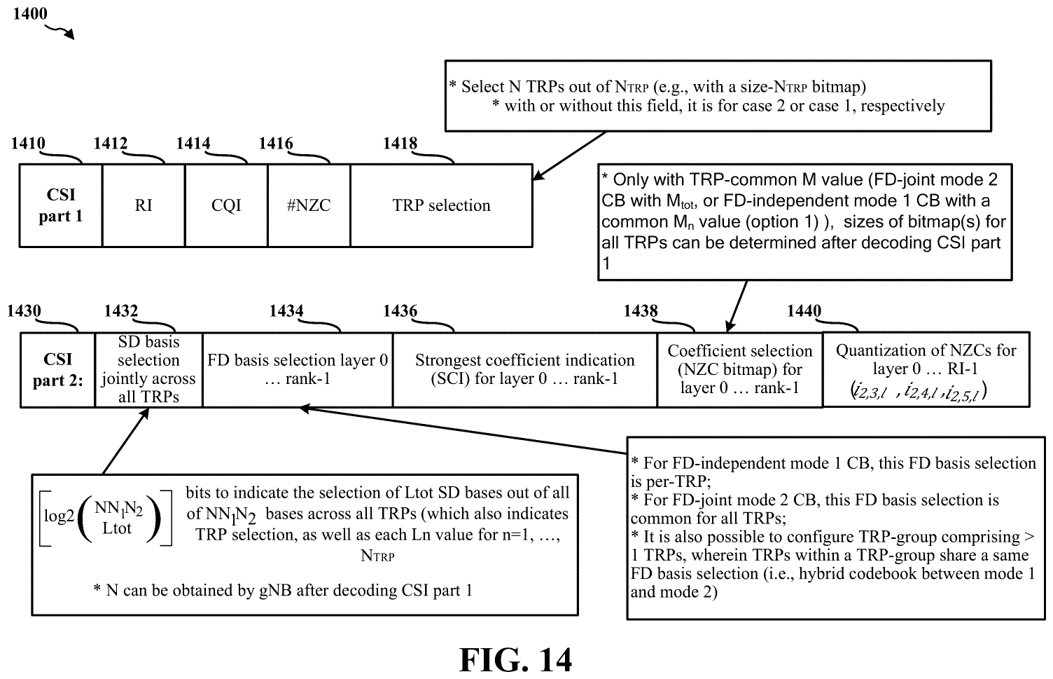

FIG. 14 is a diagram illustrating another example CSI report 1400 including a first CSI part 1410 (“CSI part 1”) and a second CSI part 1430 (“CSI part 2”), as presented herein. The configuration of the CSI report 1400 may be configured via a CJT CSI configuration, such as the CJT CSI configuration 1010 of FIG. 10. In the example of FIG. 14, the CSI report 1400 includes one or more parameters (or fields) that facilitate indicating a number of SD bases. As shown in the example of FIG. 14, a TRP selection is reported in the first CSI part 1410, and an SD basis selection jointly across TRPs is reported in the second CSI part 1430. A UE may use the example CSI report 1400 of FIG. 14 when employing either the FD-joint codebook (e.g., the mode 2 codebook of FIG. 7) with respect to the selected FD bases (Mₜₒₜ), or the FD-independent codebook (e.g., the mode 1 codebook of FIG. 7) with the selected FD bases (Mₙ) being common across the TRPs (e.g., the option 1).

In the illustrated example of FIG. 14, the first CSI part 1410 includes an RI field 1412, a CQI field 1414, a number of NZCs field 1416, and a TRP selection field 1418. The TRP selection field 1418 may indicate the selected N TRPS out of a configured number of TRPs (N_{TRP}). In some examples, the TRP selection field 1418 may be implemented as a bitmap-based TRP selection field. The bitmap-based TRP selection field may include a bitmap that includes a number of bits equal to a number (N_{TRP}) of possible TRPs available for CJT communication. For example, for N_{TRP}=4, the bitmap may include a set of 4 bits with each bit corresponding to a particular TRP in the set of four possible TRPs. As an example, a first value (e.g., a “1”) may indicate that the corresponding TRP is selected, and a second value (e.g., a “0”) may indicate that the corresponding TRP is not selected. As an example, a first bit of the bitmap may correspond to TRP A, a second bit of the bitmap may correspond to TRP B, a third bit of the bitmap may correspond to TRP C, and a fourth bit of the bitmap may correspond to TRP D. In such an example, a bitmap value of {0101} may indicate that TRP B and TRP D are selected by the UE.

In some examples, the first CSI part 1410 may include the TRP selection field 1418 when the UE is selecting the TRPs, as indicated by the second case 1120 of FIG. 11. In some examples, the first CSI part 1410 may exclude the TRP selection field 1418 when the network is selecting the TRPs, as indicated by the first case 1110 of FIG. 11.

Similar to the example second CSI part 930 of FIG. 9, the example second CSI part 1430 of FIG. 14 includes an SD basis selection field 1432, an FD basis selection field 1434, a strongest coefficient indication field 1436, a coefficient selection indication field 1438, and a NZCs indication field 1440.

The SD basis selection field 1432 may indicate the selection of SD bases (Lₜₒₜ) out of all NN₁N₂ beams in a joint way. The value of N may be determined by the base station after decoding the first CSI part 1410, as described in connection with the 1060 of FIG. 10. The size (e.g., bit width) of the SD basis selection field 1432 may be based on the selected number of TRPs (N) and a number of beams for each TRP (N₁N₂). For example, the size of the SD basis selection field 1432 may be

$$⌈ {log}_{2} ( \begin{matrix}{NN}_{1} {N}_{2} \\ {L}_{tot}\end{matrix} ) ⌉$$

bits. It may be appreciated that the SD basis selection field 1432 may implicitly indicate which N TRPs out of all the TRPs (N_{TRP}) are selected, as well as the selected number of SD bases (Lₙ) for each TRP n=1, . . . , N.

The FD basis selection field 1434 may indicate the selected FD bases. In examples in which the UE is employing the FD-independent codebook (e.g., the mode 1 codebook of FIG. 7), the FD basis selection indicated by the FD basis selection field 1434 may be per-TRP. In examples in which the UE is employing the FD-joint codebook (e.g., the mode 2 codebook of FIG. 7), the FD basis selection indicated by the FD basis selection field 1434 may be common for all TRPs. In some examples, it may be possible to configure a TRP-group including more than one TRP, where TRPs within the TRP-group share a same FD basis selection, such as a hybrid codebook between mode 1 and mode 2).

In the illustrated example of FIG. 14, the sizes of the bitmaps of all TRPs, which may be associated with the coefficient selection indication field 1438 of the second CSI part 1430, may be determined after decoding the first CSI part 1410. Additionally, the sizes of the bitmaps may be determined when the UE is employing a TRP-common number of selected FD bases (M), such as when the UE is employing the FD-joint codebook (e.g., the mode 2 codebook of FIG. 7) or the first option of the FD-independent codebook (e.g., the mode 1 codebook of FIG. 7). In examples in which the UE is employing the FD-joint codebook, the number of selected FD bases may be a total number of selected FD bases (Mₜₒₜ). In examples in which the UE is employing the first option of the FD-independent codebook, the number of selected FD bases may be common for each TRP (Mₙ).

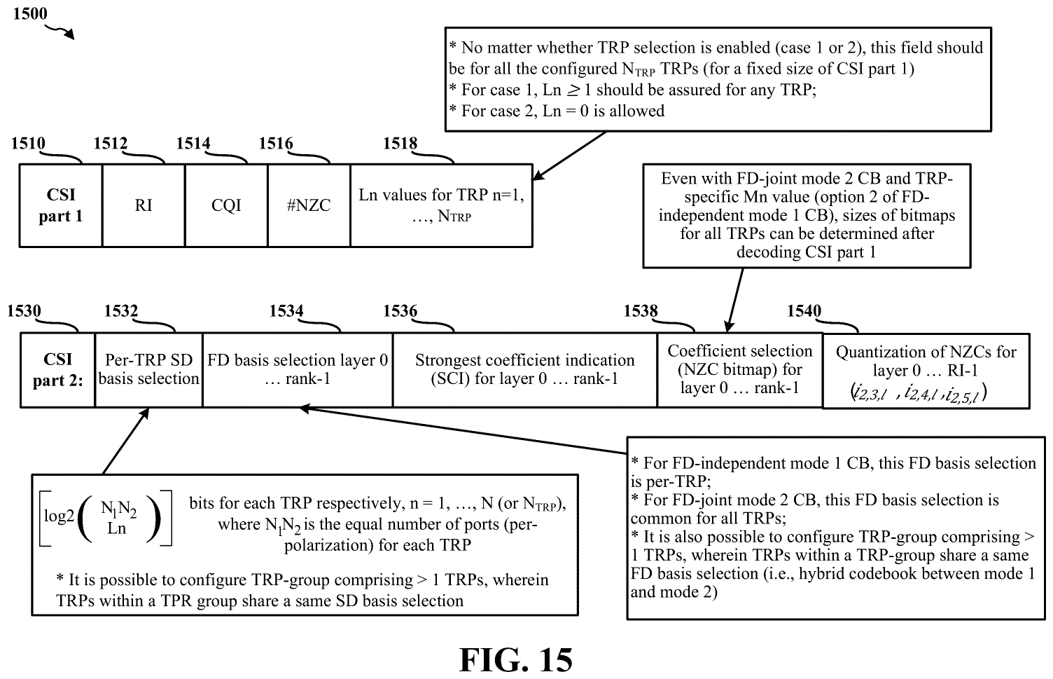

FIG. 15 is a diagram illustrating another example CSI report 1500 including a first CSI part 1510 (“CSI part 1”) and a second CSI part 1530 (“CSI part 2”), as presented herein. The configuration of the CSI report 1500 may be configured via a CJT CSI configuration, such as the CJT CSI configuration 1010 of FIG. 10. In the example of FIG. 15, the CSI report 1500 includes one or more parameters (or fields) that facilitate indicating a number of SD bases. As shown in the example of FIG. 15, a number of selected bases (Lₙ) for all of the configured TRPs (N_{TRP}) are reported in the first CSI part 1510, and a per-TRP SD basis selection is reported in the second CSI part 1530.

In the illustrated example of FIG. 15, the first CSI part 1510 includes an RI field 1512, a CQI field 1514, a number of NZCs field 1516, and a number of selected SD bases per TRP field 1518. The number of selected SD bases per TRP field 1518 indicates the number of SD bases (Lₙ) that are selected for each TRP. The number of selected SD bases per TRP field 1518 may be included regardless of whether TRP selection by the UE is enabled (e.g., the first case 1110 versus the second case 1120 of FIG. 11). Additionally, the number of selected SD bases per TRP field 1518 may be included for all configured TRPs (N_{TRP}) so that the size of the first CSI part 1510 is fixed. In scenarios in which the network selects the TRPs (e.g., the first case 1110 of FIG. 11), the value of the number of selected SD bases for each TRP included in the first CSI part 1510 is at least one. In scenarios in which the UE may select the TRPs (e.g., the second case 1120 of FIG. 12), the value of the number of selected SD bases for a TRP may be set to zero.

In the illustrated example of FIG. 15, the second CSI part 1530 includes a per-TRP SD basis selection field 1532 that indicates the selected SD bases for each TRP. In the example of the first case 1110 in which the network selects the TRPs, the selected SD bases may be for each TRP, for n=1, . . . . N_{TRP}. In the example of the second case 1120, in which the UE selects the TRPs, the selected SD bases may be for each TRP, for n=1, . . . , N. In some examples, it may be possible to configure a TRP-group including more than one TRP, where TRPs within the TRP-group share a same SD basis selection.

The size (e.g., bit width) of the per-TRP SD basis selection field 1532 may be based on a number of beams for each TRP (N₁N₂). For example, the size of the per-TRP SD basis selection field 1532 may be

$$⌈ {log}_{2} ( \begin{matrix}{N}_{1} {N}_{2} \\ {L}_{n}\end{matrix} ) ⌉$$

bits. It may be appreciated that the number of beams for each TRP (N₁N₂) may also indicate the number of ports (e.g. per polarization) for each TRP.

As shown in FIG. 15, the second CSI part 1530 may also include an FD basis selection field 1534, a strongest coefficient indication field 1536, a coefficient selection indication field 1538, and a NZCs indication field 1540. The FD basis selection field 1534 may indicate the selected FD bases. In examples in which the UE is employing the FD-independent codebook (e.g., the mode 1 codebook of FIG. 7), the FD basis selection indicated by the FD basis selection field 1534 may be per-TRP. In examples in which the UE is employing the FD-joint codebook (e.g., the mode 2 codebook of FIG. 7), the FD basis selection indicated by the FD basis selection field 1534 may be common for all TRPs. In some examples, it may be possible to configure a TRP-group including more than one TRP, where TRPs within the TRP-group share a same FD basis selection, such as a hybrid codebook between mode 1 and mode 2).

In the illustrated example of FIG. 15, the sizes of the bitmaps of all TRPs, which may be associated with the coefficient selection indication field 1538 of the second CSI part 1530, may be determined after decoding the first CSI part 1510. Additionally, the sizes of the bitmaps may be determined when the UE is employing the FD-joint codebook (e.g., the mode 2 codebook of FIG. 7) and the TRP-specific number of selected FD basis (Mₙ) (e.g., the option 2 of the FD-independent codebook of FIG. 7).

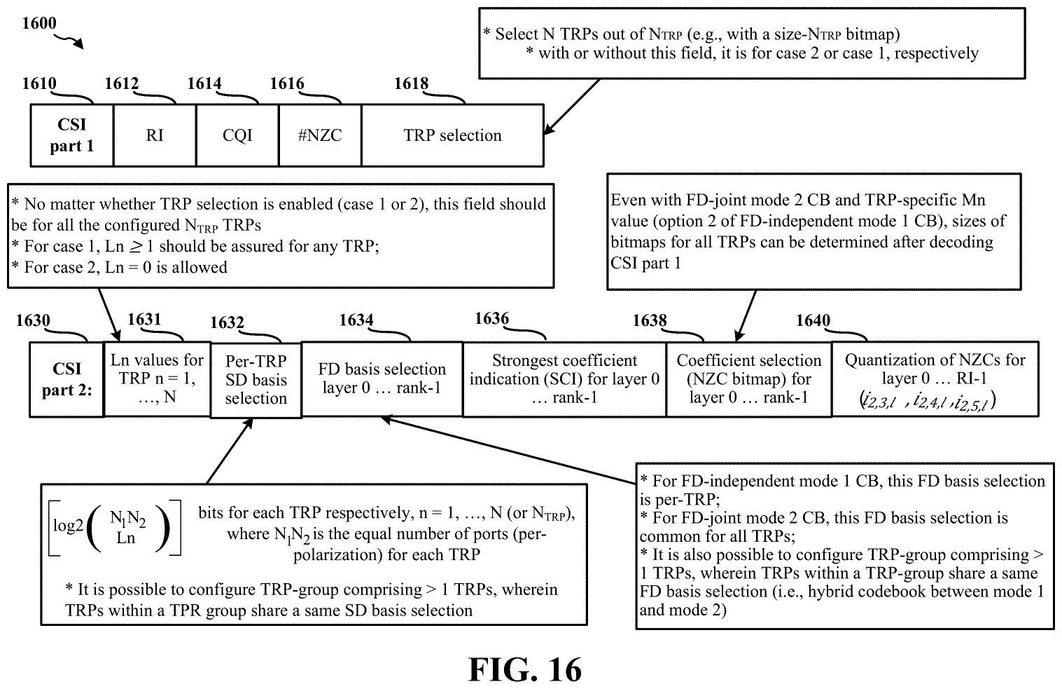

FIG. 16 is a diagram illustrating another example CSI report 1600 including a first CSI part 1610 (“CSI part 1”) and a second CSI part 1630 (“CSI part 2”), as presented herein. The configuration of the CSI report 1600 may be configured via a CJT CSI configuration, such as the CJT CSI configuration 1010 of FIG. 10. In the example of FIG. 16, the CSI report 1600 includes one or more parameters (or fields) that facilitate indicating a number of SD bases. As shown in the example of FIG. 16, a TRP selection is reported in the first CSI part 1610, and a per-TRP SD basis selection is reported in the second CSI part 1630. The second CSI part 1630 of FIG. 16 also indicates the numbers of selected SD bases (Lₙ) for all of the selected N TRPs. A UE may use the example CSI report 1600 of FIG. 16 when employing either the FD-joint codebook (e.g., the mode 2 codebook of FIG. 7) with respect to the selected FD bases (Mₜₒₜ), or the FD-independent codebook (e.g., the mode 1 codebook of FIG. 7) with the selected FD bases (Mₙ) being common across the TRPs (e.g., the option 1).

In the illustrated example of FIG. 16, the first CSI part 1610 includes an RI field 1612, a CQI field 1614, a number of NZCs field 1616, and a TRP selection field 1618. The TRP selection field 1618 may indicate the selected N TRPS out of a configured number of TRPS (N_{TRP}). In some examples, the TRP selection field 1618 may be implemented as a bitmap-based TRP selection field. Aspects of a bitmap-based TRP selection field are described in connection with the TRP selection field 1418 of FIG. 14.

In some examples, the first CSI part 1610 may include the TRP selection field 1618 when the UE is selecting the TRPs, as indicated by the second case 1120 of FIG. 11. In some examples, the first CSI part 1610 may exclude the TRP selection field 1618 when the network is selecting the TRPs, as indicated by the first case 1110 of FIG. 11.

In the illustrated example of FIG. 16, the second CSI part 1630 includes a number of selected SD bases per TRP field 1631. The number of selected SD bases per TRP field 1631 indicates the number of SD bases (Lₙ) that are selected for each TRP. The number of selected SD bases per TRP field 1631 may be included regardless of whether TRP selection by the UE is enabled (e.g., the first case 1110 versus the second case 1120 of FIG. 11). Additionally, the number of selected SD bases per TRP field 1631 may be included for all configured TRPs (N_{TRP}). In scenarios in which the network selects the TRPs (e.g., the first case 1110 of FIG. 11), the value of the number of selected SD bases (Lₙ) is at least one. In scenarios in which the UE may select the TRPs (e.g., the second case 1120 of FIG. 12), the value of the number of selected SD bases for a TRP (Lₙ) may be set to zero.

In the illustrated example of FIG. 16, the second CSI part 1630 includes a per-TRP SD basis selection field 1632 that indicates the selected SD bases for each TRP. In the example of the first case 1110 in which the network selects the TRPs, the selected SD bases may be for each TRP, for n=1, . . . . N_{TRP}. In the example of the second case 1120, in which the UE selects the TRPs, the selected SD bases may be for each TRP, for n=1, . . . , N. In some examples, it may be possible to configure a TRP-group including more than one TRP, where TRPs within the TRP-group share a same SD basis selection.

The size (e.g., bit width) of the per-TRP SD basis selection field 1632 may be based on a number of beams for each TRP (N₁N₂). For example, the size of the per-TRP SD basis selection field 1632 may be

$$⌈ {log}_{2} ( \begin{matrix}{N}_{1} {N}_{2} \\ {L}_{n}\end{matrix} ) ⌉$$

bits. It may be appreciated that the number of beams for each TRP (N₁N₂) may also indicate the number of ports (e.g. per polarization) for each TRP.

As shown in FIG. 16, the second CSI part 1630 may also include an FD basis selection field 1634, a strongest coefficient indication field 1636, a coefficient selection indication field 1638, and a NZCs indication field 1640. The FD basis selection field 1634 may indicate the selected FD bases. In examples in which the UE is employing the FD-independent codebook (e.g., the mode 1 codebook of FIG. 7), the FD basis selection indicated by the FD basis selection field 1634 may be per-TRP. In examples in which the UE is employing the FD-joint codebook (e.g., the mode 2 codebook of FIG. 7), the FD basis selection indicated by the FD basis selection field 1634 may be common for all TRPs. In some examples, it may be possible to configure a TRP-group including more than one TRP, where TRPs within the TRP-group share a same FD basis selection, such as a hybrid codebook between mode 1 and mode 2).

In the illustrated example of FIG. 16, the sizes of the bitmaps of all TRPs, which may be associated with the coefficient selection indication field 1638 of the second CSI part 1630, may be determined after decoding the first CSI part 1610. Additionally, the sizes of the bitmaps may be determined when the UE is employing the FD-joint codebook (e.g., the mode 2 codebook of FIG. 7) and the TRP-specific number of selected FD basis (Mₙ) (e.g., the option 2 of the FD-independent codebook of FIG. 7).

Referring again to the example table 1100 of FIG. 11, in some scenarios, the network may configure the number of SD bases for each TRP (Lₙ), such as described in connection with the third case 1130 and the fourth case 1140. The number of SD bases for each TRP (Lₙ) may be common value (e.g., each TRP includes a same number of SD bases) or may be TRP-specific (e.g., the network indicates a number of SD bases for each TRP).

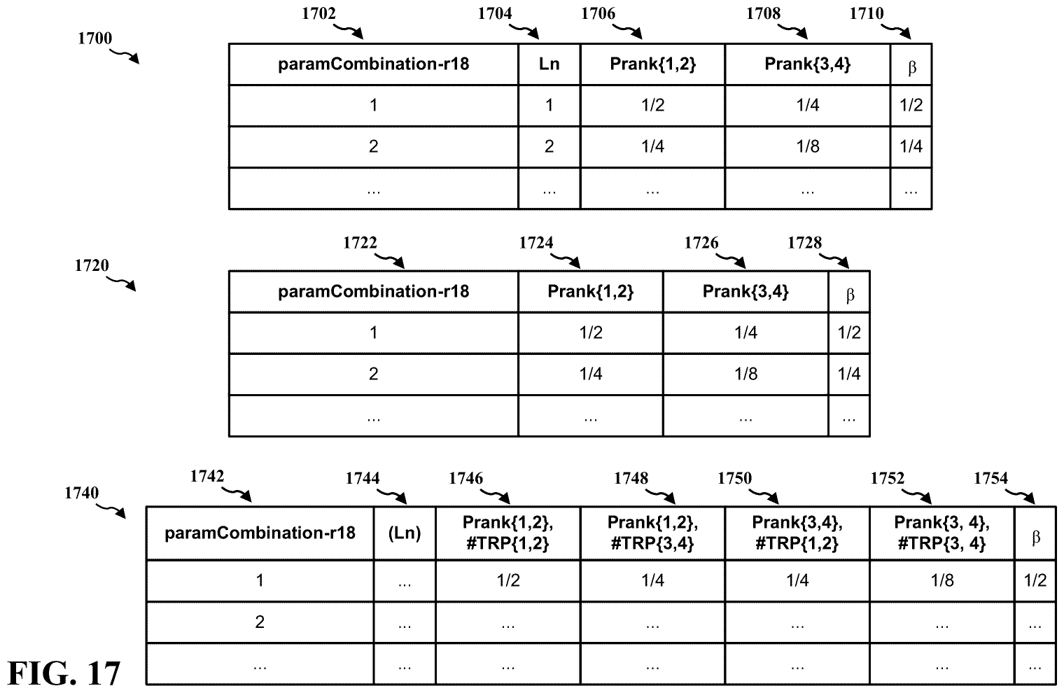

In the example of TRP-common Ly values, the network may provide a parameter combination indication that indicates a common number of selected SD bases for each TRP (e.g., a TRP-common Lₙ), a first scaling factor (p), and a second scaling factor (β). FIG. 17 depicts a portion of a first table 1700 illustrating different combinations of parameters based on a value of a parameter combination indicator 1702, as presented herein. In the example of FIG. 17, the parameter combination indicator 1702 facilitates configuring the parameters of a CSI report at a UE when employing multiple TRP communication. In some examples, the network may provide the parameter combination indicator 1702 via the CJT CSI configuration 1010 of FIG. 10.

In the example of FIG. 17, the value of the parameter combination indicator 1702 may set the value of a first parameter 1704 (Lₙ), a second parameter 1706 (p_{rank{1,2}}), a third parameter 1708 (p_{rank{3,4}}), and a fourth parameter 1710 (β). In the example of FIG. 17, and similar to the example of FIG. 8 and FIG. 12, the value of the second parameter 1706 may apply for rank 1 and for rank 2, and the value of the third parameter 1708 may apply for rank 3 and for rank 4.

In the example of FIG. 17, the value of the first parameter 1704 indicates a common number of selected SD bases for each TRP (e.g., a TRP-common Lₙ). As shown in FIG. 17, the value of the TRP-common Ly is at least one.

In the example of FIG. 17, the second parameter 1706 and the third parameter 1708 may be referred to as a first scaling factor (p) that may facilitate determining the number of selected FD bases (M). Similar to the examples of FIG. 8 and FIG. 12, the UE may use the value of the second parameter 1706 when the rank is 1 or 2, and may use the value of the third parameter 1708 when the rank is 3 or 4. In some examples, the first scaling factor (p) may be rank (pair)-specific. Additionally, the UE may use the fourth parameter 1710 (e.g., a second scaling factor) to facilitate determining the maximum number of NZCs (K₀).

In the example of TRP-specific Lₙ values, the network may provide a parameter combination indication that includes a first scaling factor (p), and a second scaling factor (β), but excludes an indication of a number of selected SD bases. For example, FIG. 17 depicts a portion of a second table 1720 illustrating different combinations of parameters based on a value of a parameter combination indicator 1722, as presented herein. In the example of FIG. 17, the parameter combination indicator 1722 facilitates configuring the parameters of a CSI report at a UE when employing multiple TRP communication. In some examples, the network may provide the parameter combination indicator 1722 via the CJT CSI configuration 1010 of FIG. 10.

In the example of the second table 1720, the value of the parameter combination indicator 1722 may set the value of a first parameter 1724 (p_{rank{1,2}}), a second parameter 1726 (p_{rank{3,4}}), and a third parameter 1728 (β). In the example of the second table 1720, and similar to the example of FIG. 8 and FIG. 12, the value of the first parameter 1724 may apply for rank 1 and for rank 2, and the value of the second parameter 1726 may apply for rank 3 and for rank 4.

In the example of FIG. 17, the second table 1720 excludes an indication of selected SD bases for each TRP. In some such examples, the selected SD bases for each TRP (Lₙ) may be configured by one or more separate parameters. For example, a first separate parameter may indicate the number of TRPs (e.g., N_{TRP}=4). A second separate parameter may indicate the number of selected SD bases for each TRP. For example, the second separate parameter may indicate a bitmap value of {2121}, which may indicate that a first TRP includes two selected SD bases (e.g., L₁=2), a second TRP includes one selected SD bases (e.g., L₂=1), a third TRP includes two selected SD bases (e.g., L₃=2), and a fourth TRP includes one selected SD bases (e.g., L₄=1).

Similar to the example of the first table 1700 of FIG. 17, in the example of the second table 1720, the first parameter 1724 and the second parameter 1726 may be referred to as a first scaling factor (p) that may facilitate determining the number of selected FD bases (M). Similar to the examples of FIG. 8 and FIG. 12, the UE may use the value of the first parameter 1724 when the rank is 1 or 2, and may use the value of the second parameter 1726 when the rank is 3 or 4. In some examples, the first scaling factor (p) may be rank (pair)-specific. Additionally, the UE may use the third parameter 1728 (e.g., a second scaling factor) to facilitate determining the maximum number of NZCs (K₀).

In some examples, for either TRP-common Lₙ values or for TRP-specific Lₙ values, it may be possible that the first scaling factor (p) is determined by a number of selected TRPs (N). By determining the first scaling factor (p) based on the number of selected TRPs (N), the CSI payload size (e.g., for a first CSI part) may be similar for different values of selected TRPs (N).

FIG. 17 depicts a portion of a third table 1740 illustrating different combinations of parameters based on a value of a parameter combination indicator 1742, as presented herein. In the example of FIG. 17, the parameter combination indicator 1742 facilitates configuring the parameters of a CSI report at a UE when employing multiple TRP communication. In some examples, the network may provide the parameter combination indicator 1742 via the CJT CSI configuration 1010 of FIG. 10.

In the example of the third table 1740, the value of the parameter combination indicator 1742 may set the value of a first parameter 1746 (p_{rank{1,2}}), a second parameter 1748 (p_{rank{1,2}}), a third parameter 1750 (p_{rank{3,4}}), a fourth parameter 1752 (p_{rank{3,4}}), and a fifth parameter 1754 (β). The parameter combination indicator 1742 may also indicate a value of a sixth parameter 1744 (Lₙ) based on if the parameter combination indicator 1742 is associated with a TRP-common Lₙ, as described in connection with the first table 1700 of FIG. 17, or is associated with a TRP-specific Lₙ, as described in connection with the second table 1720 of FIG. 17.

In the example of the third table 1740, the first parameter 1746 and the second parameter 1748 may each apply for rank 1 and for rank 2. However, the first parameter 1746 may apply when the number of TRPs is either 1 or 2 (e.g., number of TRPs={1,2}), and the second parameter 1748 may apply when the number of TRPs is either 3 or 4 (e.g., the number of TRPs={3,4}). Additionally, the third parameter 1750 and the fourth parameter 1752 may each apply for rank 3 and for rank 4. However, the third parameter 1750 may apply when the number of TRPs is either 1 or 2 (e.g., number of TRPs={1,2}), and fourth parameter 1752 may apply when the number of TRPs is either 3 or 4 (e.g., the number of TRPs={3,4}).

In the example of the third table 1740, the first parameter 1746, the second parameter 1748, the third parameter 1750, and the fourth parameter 1752 may facilitate determining the number of selected FD bases (M) based on, for example, the rank and the number of TRPs. Additionally, the UE may use the third parameter 1750 (e.g., a second scaling factor) to facilitate determining the maximum number of NZCs (K₀).

Although not shown in the examples of FIG. 17, it may be appreciated that the determination of the number of selected FD bases (M) and the maximum number of NZCs (K₀) may be calculated based on the techniques described in connection with the first case 1110 and the second case 1120 of FIG. 11. For example, the UE may use the Equations 8a, 8b, 9a, 9b, 10a, 10b, 11a, 11b, 12a, 12b, 13, 14, 15, 16, and/or 17 to determine the number of selected FD bases (M) and the maximum number of NZCs (K₀) based on whether the network selects the TRPs (e.g., the third case 1130) or the UE selects the TRPs (e.g., the fourth case 1140).

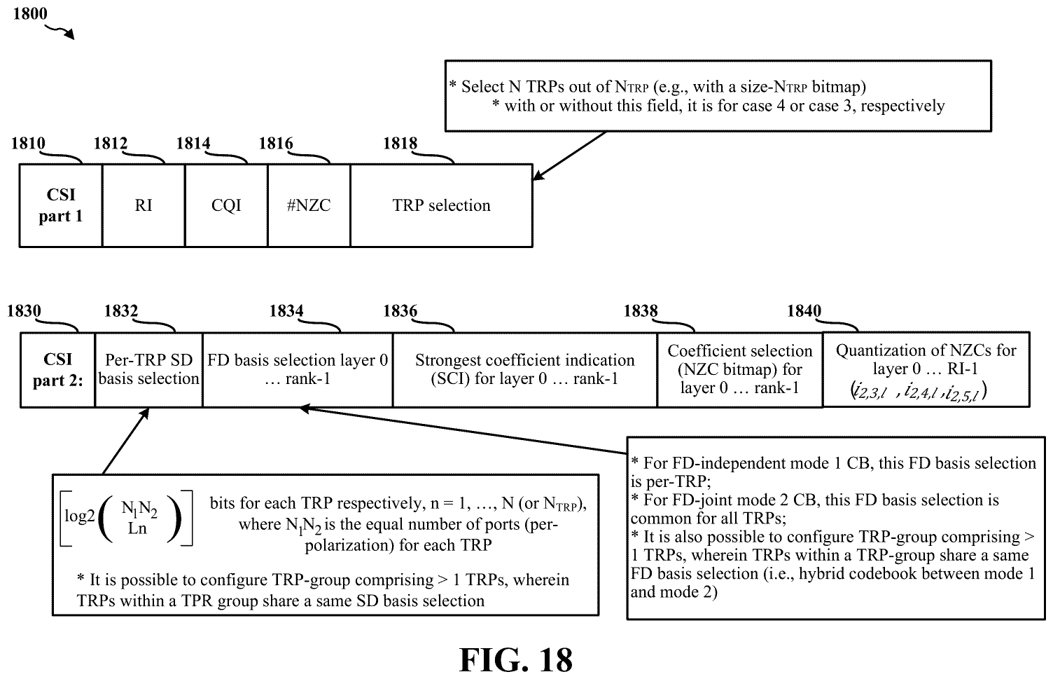

FIG. 18 is a diagram illustrating another example CSI report 1800 including a first CSI part 1810 (“CSI part 1”) and a second CSI part 1830 (“CSI part 2”), as presented herein. The configuration of the CSI report 1800 may be configured via a CJT CSI configuration, such as the CJT CSI configuration 1010 of FIG. 10. In the example of FIG. 18, the CSI report 1800 includes one or more parameters (or fields) that facilitate indicating an SD bases selection for each TRP. As shown in the example of FIG. 18, a TRP selection is reported in the first CSI part 1810, and a per-TRP SD basis selection is reported in the second CSI part 1830. A UE may use the example CSI report 1800 of FIG. 18 when employing either the FD-joint codebook (e.g., the mode 2 codebook of FIG. 7) with respect to the selected FD bases (Mₜₒₜ), or the FD-independent codebook (e.g., the mode 1 codebook of FIG. 7) with the selected FD bases (Mₙ) being common across the TRPs (e.g., the option 1).

In the illustrated example of FIG. 18, the first CSI part 1810 includes an RI field 1812, a CQI field 1814, a number of NZCs field 1816, and a TRP selection field 1818. The TRP selection field 1818 may indicate the selected N TRPS out of a configured number of TRPs (N_{TRP}). In some examples, the TRP selection field 1818 may be implemented as a bitmap-based TRP selection field. Aspects of a bitmap-based TRP selection field are described in connection with the TRP selection field 1418 of FIG. 14.

In some examples, the first CSI part 1810 may include the TRP selection field 1818 when the UE is selecting the TRPs, as indicated by the fourth case 1140 of FIG. 11. In some examples, the first CSI part 1810 may exclude the TRP selection field 1818 when the network is selecting the TRPs, as indicated by the third case 1130 of FIG. 11.

In the illustrated example of FIG. 18, the second CSI part 1830 includes a per-TRP SD basis selection field 1832 that indicates the selected SD bases for each TRP. In the example of the third case 1130 in which the network selects the TRPs, the selected SD bases may be for each TRP, for n=1, . . . . N_{TRP}. In the example of the fourth case 1140, in which the UE selects the TRPs, the selected SD bases may be for each TRP, for n=1, . . . , N. In some examples, it may be possible to configure a TRP-group including more than one TRP, where TRPs within the TRP-group share a same SD basis selection.

The size (e.g., bit width) of the per-TRP SD basis selection field 1832 may be based on a number of beams for each TRP (N₁N₂). For example, the size of the per-TRP SD basis selection field 1832 may be

$$⌈ {log}_{2} ( \begin{matrix}{N}_{1} {N}_{2} \\ {L}_{n}\end{matrix} ) ⌉$$

bits. It may be appreciated that the number of beams for each TRP (N₁N₂) may also indicate the number of ports (e.g. per polarization) for each TRP.

As shown in FIG. 18, the second CSI part 1630 may also include an FD basis selection field 1834, a strongest coefficient indication field 1836, a coefficient selection indication field 1838, and a NZCs indication field 1840. The FD basis selection field 1834 may indicate the selected FD bases. In examples in which the UE is employing the FD-independent codebook (e.g., the mode 1 codebook of FIG. 7), the FD basis selection indicated by the FD basis selection field 1834 may be per-TRP. In examples in which the UE is employing the FD-joint codebook (e.g., the mode 2 codebook of FIG. 7), the FD basis selection indicated by the FD basis selection field 1834 may be common for all TRPs. In some examples, it may be possible to configure a TRP-group including more than one TRP, where TRPs within the TRP-group share a same FD basis selection, such as a hybrid codebook between mode 1 and mode 2).

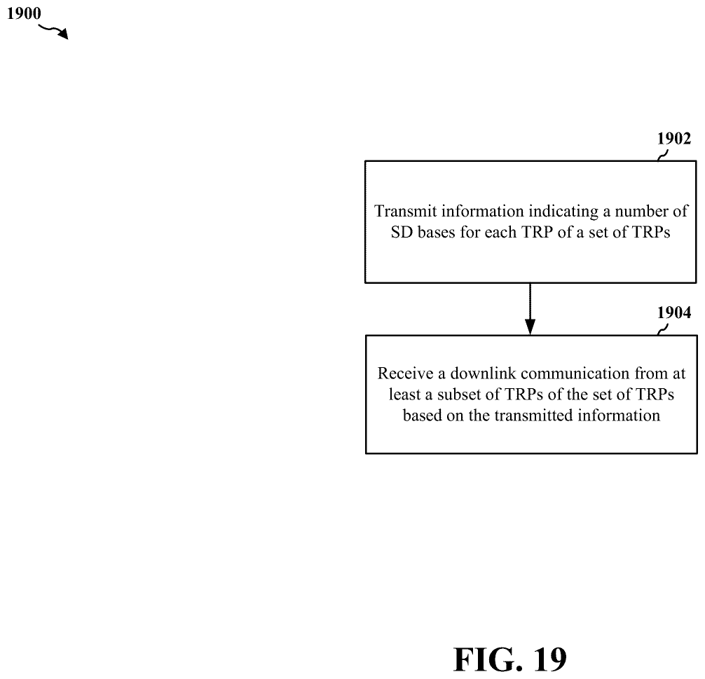

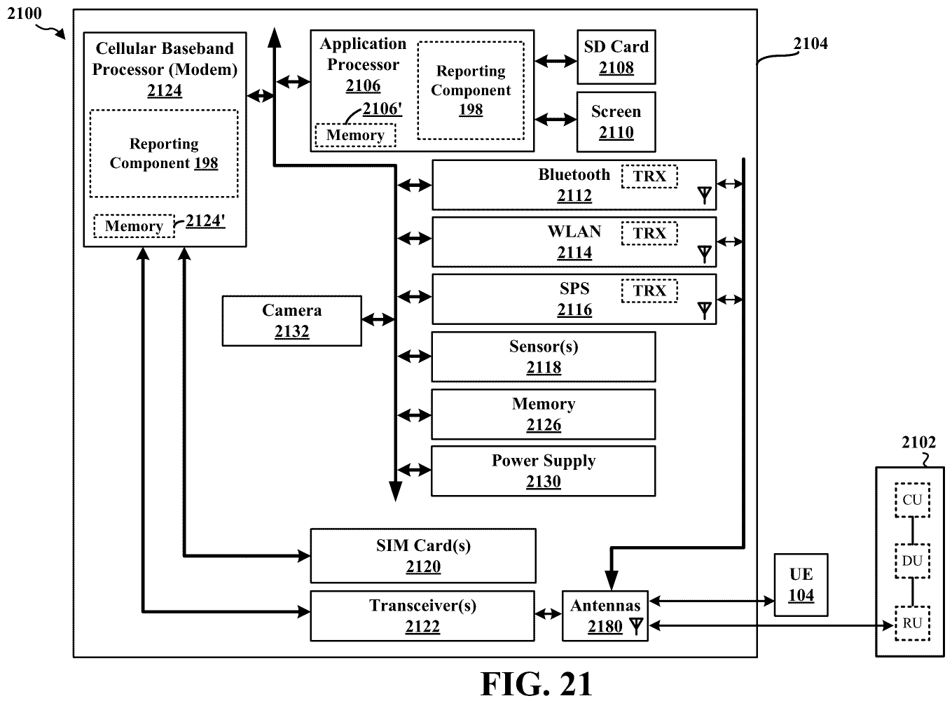

FIG. 19 is a flowchart 1900 of a method of wireless communication. The method may be performed by a UE (e.g., the UE 104, and/or an apparatus 2104 of FIG. 21). The method may facilitate indicating a number of SD bases, which may improve communication performance in scenarios employing multiple TRP communication. For example, the method may be used by the UE when employing the first configuration of FIG. 10, and/or the first case 1110 and/or the second case 1120 of FIG. 11.

At 1902, the UE transmits information indicating a number of SD bases for each TRP of a set of TRPs, as described in connection with at least the CSI report 1050 of FIG. 10. The transmitting of the information indicating the number of SD bases, at 1902, may be performed by a cellular RF transceiver 2122/the reporting component 198 of the apparatus 2104 of FIG. 21.

At 1904, the UE receives a downlink communication from at least a subset of TRPs of the set of TRPs based on the transmitted information, as described in connection with at least downlink communication 1070 of FIG. 10. The receiving of the downlink communication, at 1904, may be performed by the cellular RF transceiver 2122/the reporting component 198 of the apparatus 2104 of FIG. 21.

In some examples, the UE may determine a number of FD bases for each TRP of the set of TRPs based on at least one of the number of SD bases for each TRP of the set of TRPs or a number of TRPs of the set of TRPs, as described in connection with at least Equations 8a, 8b, 9a, 9b, 10a, 10b, 11a, 11b, 12a, and/or 12b. In some such examples, the receiving of the downlink communication from the at least the subset of TRPs, at 1904, may be further based on the determined number of FD bases for each TRP of the set of TRPs.

In some examples, the determined number of FD bases for each TRP of the set of TRPs may be a same number, as described in connection with at least the FD-joint codebook (e.g., the mode 2 codebook) and/or the TRP-common Mₙ scenario (e.g., option 1 of the FD-independent codebook or the mode 1 codebook).

In some examples, the determined number of FD bases for each TRP of the set of TRPs may be a specific number to each respective TRP, as described in connection with at least the TRP-specific Mₙ scenario (e.g., option 2 of the FD-independent codebook or the mode 1 codebook).

In some examples, a sum of each number of SD bases for each TRP of the set of TRPs may be equal to a total number of SD bases Lₜₒₜ, and where the transmitted information (e.g., at 1902) further includes an actual number of SD bases Lₜₒₜ, actual, which may be less than the total number of SD bases Lₜₒₜ, as described in connection with at least the second case 1120 of FIG. 11.

In some examples, the transmitted information (e.g., at 1902) may indicate that the number of SD bases for each of the TRPs of the set of TRPs is at least one, as described in connection with at least the first case 1110 of FIG. 11.

In some examples, the transmitted information (e.g., at 1902) may indicate that the number of SD bases for one or more TRPs of the set of TRPs is equal to 0, as described in connection with at least the second case 1120 of FIG. 11.

In some examples, the UE may determine a maximum number of NZCs for the set of TRPs based on at least one of the number of SD bases for each TRP of the set of TRPs or a total number of TRPs of the set of TRPs, as described in connection with at least Equations 13, 14, 15, and/or 16. In some such examples, the receiving of the downlink communication from the at least the subset of TRPs (e.g., at 1904) may be further based on the determined maximum number of NZCs for the set of TRPs.

In some examples, the transmitted information (e.g., at 1902) may include a CSI part 1, the CSI part 1 including an RI, a CQI, a maximum number of NZCs, and an indication of SD bases selected jointly across the set of TRPs associated with the number of SD bases for each TRP of the set of TRPs, as described in connection with at least the example CSI report 1300 of FIG. 13.

In some examples, the transmitted information (e.g., at 1902) may include a CSI part 1 and a CSI part 2, where the CSI part 1 includes an RI, a CQI, a maximum number of NZCs, and a TRP selection indicating selected TRPs of the set of TRPs, and where the CSI part 2 includes at least an indication of SD bases selected jointly across the selected TRPs associated with the number of SD bases for each TRP of the selected TRPs, as described in connection with at least the example CSI report 1400 of FIG. 14.

In some examples, the transmitted information (e.g., at 1902) may include a CSI part 1 and a CSI part 2, where the CSI part 1 includes an RI, a CQI, a maximum number of NZCs, and the number of SD bases for each TRP of the set of TRPs, and where the CSI part 2 includes a per-TRP SD basis selection for each TRP of the set of TRPs or selected TRPs of the set of TRPs, as described in connection with at least the example CSI report 1500 of FIG. 15.

In some examples, the transmitted information (e.g., at 1902) may include a CSI part 1 and a CSI part 2, where the CSI part 1 includes an RI, a CQI, a maximum number of NZCs, and a TRP selection indicating selected TRPs of the set of TRPs, and where the CSI part 2 includes at least the number of SD bases for each TRP of the selected TRPs of the set of TRPs and a per-TRP SD basis selection for the selected TRPs of the set of TRPs, as described in connection with at least the example CSI report 1600 of FIG. 16.

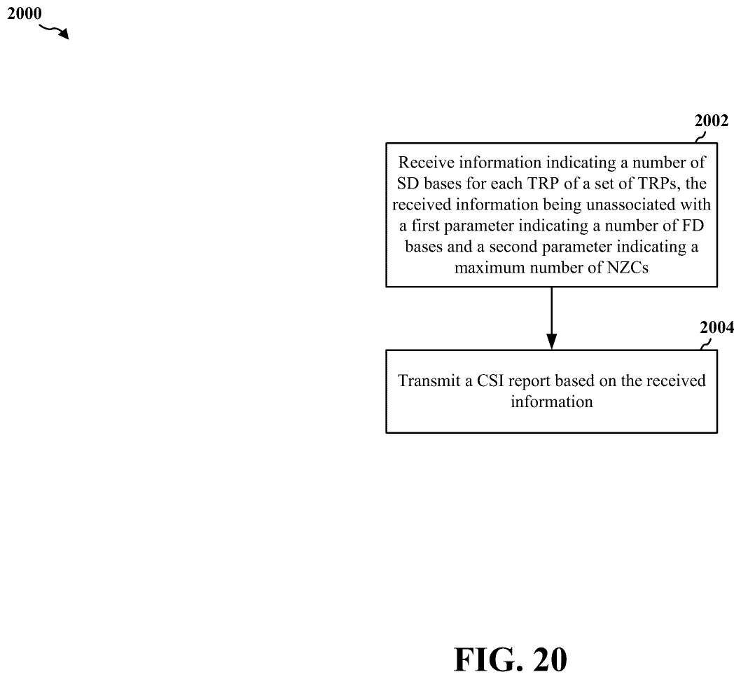

FIG. 20 is a flowchart 2000 of a method of wireless communication. The method may be performed by a UE (e.g., the UE 104, and/or an apparatus 2104 of FIG. 21). The method may facilitate transmitting a CSI report based on received information indicating a number of SD bases, which may improve communication performance in scenarios employing multiple TRP communication. For example, the method may be used by the UE when employing the second configuration of FIG. 10, and/or the third case 1130 and/or the fourth case 1140 of FIG. 11.

At 2002, the UE receives information indicating a number of SD bases for each TRP of a set of TRPs, as described in connection with at least the CJT CSI configuration 1010 of FIG. 10. The received information may be unassociated with a first parameter indicating a number of FD bases and a second parameter indicating a maximum number of NZCs. In some examples, the first parameter may be based on a number of TRPs of the set of TRPs. The receiving of the information indicating the number of SD bases, at 2002, may be performed by a cellular RF transceiver 2122/the reporting component 198 of the apparatus 2104 of FIG. 21.

At 2004, the UE transmits a CSI report based on the received information, as described in connection with at least the CSI report 1050 of FIG. 10 and/or the CSI report 1800 of FIG. 18. The transmitting of the CSI report, at 2004, may be performed the cellular RF transceiver 2122/the reporting component 198 of the apparatus 2104 of FIG. 21.

In some examples, the CSI report, at 2004, includes a CSI part 1 and a CSI part 2, where the CSI part 1 includes an RI, a CQI, a maximum number of NZCs, and a TRP selection indicating selected TRPs of the set of TRPs, and where the CSI part 2 includes at least a per-TRP SD basis selection for the selected TRPs of the set of TRPs, as described in connection with the example CSI report 1800 of FIG. 18.

FIG. 21 is a diagram 2100 illustrating an example of a hardware implementation for an apparatus 2104. The apparatus 2104 may be a UE, a component of a UE, or may implement UE functionality. In some aspects, the apparatus 2104 may include a cellular baseband processor 2124 (also referred to as a modem) coupled to one or more transceivers (e.g., a cellular RF transceiver 2122). The cellular baseband processor 2124 may include on-chip memory 2124′. In some aspects, the apparatus 2104 may further include one or more subscriber identity modules (SIM) cards 2120 and an application processor 2106 coupled to a secure digital (SD) card 2108 and a screen 2110. The application processor 2106 may include on-chip memory 2106′. In some aspects, the apparatus 2104 may further include a Bluetooth module 2112, a WLAN module 2114, an SPS module 2116 (e.g., GNSS module), one or more sensor modules 2118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2126, a power supply 2130, and/or a camera 2132. The Bluetooth module 2112, the WLAN module 2114, and the SPS module 2116 may include an on-chip transceiver (TRX) (or in some cases, just a receiver (RX)). The Bluetooth module 2112, the WLAN module 2114, and the SPS module 2116 may include their own dedicated antennas and/or utilize one or more antennas 2180 for communication. The cellular baseband processor 2124 communicates through transceiver(s) (e.g., the cellular RF transceiver 2122) via one or more antennas 2180 with the UE 104 and/or with an RU associated with a network entity 2102. The cellular baseband processor 2124 and the application processor 2106 may each include a computer-readable medium/memory, such as the on-chip memory 2124′, and the on-chip memory 2106′, respectively. The additional memory modules 2126 may also be considered a computer-readable medium/memory. Each computer-readable medium/memory (e.g., the on-chip memory 2124′, the on-chip memory 2106′, and/or the additional memory modules 2126) may be non-transitory. The cellular baseband processor 2124 and the application processor 2106 are each responsible for general processing, including the execution of software stored on the computer-readable medium/memory. The software, when executed by the cellular baseband processor 2124/application processor 2106, causes the cellular baseband processor 2124/application processor 2106 to perform the various functions described supra. The computer-readable medium/memory may also be used for storing data that is manipulated by the cellular baseband processor 2124/application processor 2106 when executing software. The cellular baseband processor 2124/application processor 2106 may be a component of the UE 350 and may include the memory 360 and/or at least one of the TX processor 368, the RX processor 356, and the controller/processor 359. In one configuration, the apparatus 2104 may be a processor chip (modem and/or application) and include just the cellular baseband processor 2124 and/or the application processor 2106, and in another configuration, the apparatus 2104 may be the entire UE (e.g., see the UE 350 of FIG. 3) and include the additional modules of the apparatus 2104.

As discussed supra, the reporting component 198 is configured to transmit information indicating a number of SD bases for each TRP of a set of TRPs. The reporting component 198 may also be configured to receive a downlink communication from at least a subset of TRPs of the set of TRPs based on the transmitted information. In another configuration, the reporting component 198 may be configured to receive information indicating a number of SD bases for each TRP of a set of TRPs, the received information being unassociated with a first parameter indicating a number of FD bases and a second parameter indicating a maximum number of NZCs. The reporting component 198 may also be configured to transmit a CSI report based on the received information.

The reporting component 198 may be within the cellular baseband processor 2124, the application processor 2106, or both the cellular baseband processor 2124 and the application processor 2106. The reporting component 198 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 2104 may include a variety of components configured for various functions. For example, the reporting component 198 may include one or more hardware components that perform each of the blocks of the algorithm in the flowcharts of FIGS. 19 and/or 20.

In one configuration, the apparatus 2104, and in particular the cellular baseband processor 2124 and/or the application processor 2106, includes means for transmitting information indicating a number of SD bases for each TRP of a set of TRPs. The example apparatus 2104 also includes means for receiving a downlink communication from at least a subset of TRPs of the set of TRPs based on the transmitted information.

In another configuration, the example apparatus 2104 also includes means for determining a number of FD bases for each TRP of the set of TRPs based on at least one of the number of SD bases for each TRP of the set of TRPs or a number of TRPs of the set of TRPs.

In another configuration, the example apparatus 2104 also includes means for determining a maximum number of NZCs for the set of TRPs based on at least one of the number of SD bases for each TRP of the set of TRPs or a total number of TRPs of the set of TRPs.

In another configuration, the example apparatus 2104 includes means for receiving information indicating a number of SD bases for each TRP of a set of TRPs, the received information being unassociated with a first parameter indicating a number of FD bases and a second parameter indicating a maximum number of NZCs. The example apparatus 2104 also includes means for transmitting a CSI report based on the received information.

The means may be the reporting component 198 of the apparatus 2104 configured to perform the functions recited by the means. As described supra, the apparatus 2104 may include the TX processor 368, the RX processor 356, and the controller/processor 359. As such, in one configuration, the means may be the TX processor 368, the RX processor 356, and/or the controller/processor 359 configured to perform the functions recited by the means.

In a multiple TRP communications system, a network entity and a UE may communicate with each other by sending communications using one or more of multiple TRPs. In examples in which the network entity and the UE are operating in a multiple TRP communication mode, the UE may generate CSI for one or more of the TRPs when performing a channel state feedback procedure. Thus, it may be appreciated that as the quantity of TRPs increases, the size of the CSI report may also increase.

Aspects disclosed herein provide techniques for improving communication performance in scenarios employing multiple TRP communication, for example, by improving CSI acquisition for CJT communications. For example, aspects disclosed herein enable a UE to select a number of SD bases, a number of FD bases, and a number of NZCs to include in a CSI report to the network. In some aspects disclosed herein, the UE may transmit information indicating a number of SD bases for each TRP of a set of TRPs. The UE may indicate the number of SD bases in a CSI part 1 of a CSI report or in a CSI part 2 of the CSI report. The UE may then receive a downlink communication from at least a subset of TRPs of the set of TRPs. In another aspect disclosed herein, the UE may receive information indicating a number of SD bases for each TRP of a set of TRPs. The received information may be unassociated with a first parameter indicating a number of FD bases and a second parameter indicating a maximum number of NZCs. The UE may also transmit a CSI report based on the received information. The UE may include an indication of selected TRPs in a CSI part 1 of the CSI report, and include an indication of per-TRP SD basis selection in a CSI part 2 of the CSI report.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a UE, including: transmitting information indicating a number of spatial domain (SD) bases for each transmission reception point (TRP) of a set of TRPs; and receiving a downlink communication from at least a subset of TRPs of the set of TRPs based on the transmitted information.
Aspect 2 is the method of aspect 1, further including: determining a number of frequency domain (FD) bases for each TRP of the set of TRPs based on at least one of the number of SD bases for each TRP of the set of TRPs or a number of TRPs of the set of TRPs, where receiving the downlink communication from the at least the subset of TRPs is further based on the determined number of FD bases for each TRP of the set of TRPs.
Aspect 3 is the method of aspect 2, further including that the determined number of FD bases for each TRP of the set of TRPs is a same number.
Aspect 4 is the method of aspect 2, further including that the determined number of FD bases for each TRP of the set of TRPs is a specific number to each respective TRP.
Aspect 5 is the method of any of aspects 1 to 4, further including that a sum of each number of SD bases for each TRP of the set of TRPs is equal to a total number of SD bases Lₜₒₜ, and wherein the transmitted information further includes an actual number of SD bases Lₜₒₜ, actual, which is less than the total number of SD bases Lₜₒₜ.
Aspect 6 is the method of any of aspects 1 to 5, further including that the transmitted information indicates that the number of SD bases for each of the TRPs of the set of TRPs is at least one.
Aspect 7 is the method of any of aspects 1 to 5, further including that the transmitted information indicates that the number of SD bases for one or more TRPs of the set of TRPs is equal to 0.
Aspect 8 is the method of any of aspects 1 to 7, further including: determining a maximum number of non-zero coefficients (NZCs) for the set of TRPs based on at least one of the number of SD bases for each TRP of the set of TRPs or a total number of TRPs of the set of TRPs, where receiving the downlink communication from the at least the subset of TRPs is further based on the determined maximum number of NZCs for the set of TRPs.
Aspect 9 is the method of any of aspects 1 to 8, further including that the transmitted information comprises a channel state information (CSI) part 1, the CSI part 1 including a rank indicator (RI), a channel quality indicator (CQI), a total number of non-zero coefficients (NZCs), and an indication of SD bases selected jointly across the set of TRPs associated with the number of SD bases for each TRP of the set of TRPs.
Aspect 10 is the method of any of aspects 1 to 8, further including that the transmitted information comprises a channel state information (CSI) part 1 and a CSI part 2, wherein the CSI part 1 includes a rank indicator (RI), a channel quality indicator (CQI), a total number of non-zero coefficients (NZCs), and a TRP selection indicating selected TRPs of the set of TRPs, wherein the CSI part 2 includes at least an indication of SD bases selected jointly across the selected TRPs associated with the number of SD bases for each TRP of the selected TRPs.
Aspect 11 is the method of any of aspects 1 to 8, further including that the transmitted information comprises a channel state information (CSI) part 1 and a CSI part 2, wherein the CSI part 1 includes a rank indicator (RI), a channel quality indicator (CQI), a total number of non-zero coefficients (NZCs), and the number of SD bases for each TRP of the set of TRPs, and wherein the CSI part 2 includes a per-TRP SD basis selection for each TRP of the set of TRPs or selected TRPs of the set of TRPs.
Aspect 12 is the method of any of aspects 1 to 8, further including that the transmitted information comprises a channel state information (CSI) part 1 and a CSI part 2, wherein the CSI part 1 includes a rank indicator (RI), a channel quality indicator (CQI), a total number of non-zero coefficients (NZCs), and a TRP selection indicating selected TRPs of the set of TRPs, wherein the CSI part 2 includes at least the number of SD bases for each TRP of the selected TRPs of the set of TRPs and a per-TRP SD basis selection for the selected TRPs of the set of TRPs.
Aspect 13 is an apparatus for wireless communication at a UE including at least one processor coupled to a memory and configured to implement any of aspects 1 to 12.
In aspect 14, the apparatus of aspect 13 further includes at least one antenna coupled to the at least one processor.
In aspect 15, the apparatus of aspect 13 or 14 further includes a transceiver coupled to the at least one processor.
Aspect 16 is an apparatus for wireless communication including means for implementing any of aspects 1 to 12.
In aspect 17, the apparatus of aspect 16 further includes at least one antenna coupled to the means to perform the method of any of aspects 1 to 12.
In aspect 18, the apparatus of aspect 16 or 17 further includes a transceiver coupled to the means to perform the method of any of aspects 1 to 12.
Aspect 19 is a non-transitory computer-readable storage medium storing computer executable code, where the code, when executed, causes a processor to implement any of aspects 1 to 12.
Aspect 20 is a method of wireless communication at a UE, including: receiving information indicating a number of spatial domain (SD) bases for each transmission reception point (TRP) of a set of TRPs, the received information being unassociated with a first parameter indicating a number of frequency domain (FD) bases and a second parameter indicating a maximum number of non-zero coefficients (NZCs); and transmitting a channel state information (CSI) report based on the received information.
Aspect 21 is the method of aspect 20, further including that the first parameter is based on a number of TRPs of the set of TRPs.
Aspect 22 is the method of any of aspects 20 and 21, further including that the CSI report comprises a CSI part 1 and a CSI part 2, wherein the CSI part 1 includes a rank indicator (RI), a channel quality indicator (CQI), a total number of NZCs, and a TRP selection indicating selected TRPs of the set of TRPs, where the CSI part 2 includes at least a per-TRP SD basis selection for the selected TRPs of the set of TRPs.
Aspect 23 is an apparatus for wireless communication at a UE including at least one processor coupled to a memory and configured to implement any of aspects 20 to 22.
In aspect 24, the apparatus of aspect 23 further includes at least one antenna coupled to the at least one processor.
In aspect 25, the apparatus of aspect 23 or 24 further includes a transceiver coupled to the at least one processor.
Aspect 26 is an apparatus for wireless communication including means for implementing any of aspects 20 to 22.
In aspect 27, the apparatus of aspect 26 further includes at least one antenna coupled to the means to perform the method of any of aspects 20 to 22.
In aspect 28, the apparatus of aspect 26 or 27 further includes a transceiver coupled to the means to perform the method of any of aspects 20 to 22.
Aspect 29 is a non-transitory computer-readable storage medium storing computer executable code, where the code, when executed, causes a processor to implement any of aspects 20 to 22.

1. An apparatus for wireless communication at a user equipment (UE), comprising
a memory; and
at least one processor coupled to the memory and, based at least in part on information stored in the memory, the at least one processor is configured to:
transmit information indicating a number of spatial domain (SD) bases for each transmission reception point (TRP) of a set of TRPs; and
receive a downlink communication from at least a subset of TRPs of the set of TRPs based on the transmitted information.

2. The apparatus of claim 1, wherein the at least one processor is further configured to determine a number of frequency domain (FD) bases for each TRP of the set of TRPs based on at least one of the number of SD bases for each TRP of the set of TRPs or a number of TRPs of the set of TRPs, wherein the at least one processor is configured to receive the downlink communication from the at least the subset of TRPs further based on the determined number of FD bases for each TRP of the set of TRPs.

3. The apparatus of claim 2, wherein the determined number of FD bases for each TRP of the set of TRPs is a same number.

4. The apparatus of claim 2, wherein the determined number of FD bases for each TRP of the set of TRPs is a specific number to each respective TRP.

5. The apparatus of claim 1, wherein a sum of each number of SD bases for each TRP of the set of TRPs is equal to a total number of SD bases Lₜₒₜ, and wherein the transmitted information further includes an actual number of SD bases L_{tot,actual}, which is less than the total number of SD bases Lₜₒₜ.

6. The apparatus of claim 1, wherein the transmitted information indicates that the number of SD bases for each of the TRPs of the set of TRPs is at least one.

7. The apparatus of claim 1, wherein the transmitted information indicates that the number of SD bases for one or more TRPs of the set of TRPs is equal to 0.

8. The apparatus of claim 1, wherein the at least one processor is further configured to determine a maximum number of non-zero coefficients (NZCs) for the set of TRPs based on at least one of the number of SD bases for each TRP of the set of TRPs or a total number of TRPs of the set of TRPs, wherein the at least one processor is configured to receive the downlink communication from the at least the subset of TRPs further based on the determined maximum number of NZCs for the set of TRPs.

9. The apparatus of claim 1, wherein the transmitted information comprises a channel state information (CSI) part 1, the CSI part 1 including a rank indicator (RI), a channel quality indicator (CQI), a total number of non-zero coefficients (NZCs), and an indication of SD bases selected jointly across the set of TRPs associated with the number of SD bases for each TRP of the set of TRPs.

10. The apparatus of claim 1, wherein the transmitted information comprises a channel state information (CSI) part 1 and a CSI part 2, wherein the CSI part 1 includes a rank indicator (RI), a channel quality indicator (CQI), a total number of non-zero coefficients (NZCs), and a TRP selection indicating selected TRPs of the set of TRPs, wherein the CSI part 2 includes at least an indication of SD bases selected jointly across the selected TRPs associated with the number of SD bases for each TRP of the selected TRPs.

11. The apparatus of claim 1, wherein the transmitted information comprises a channel state information (CSI) part 1 and a CSI part 2, wherein the CSI part 1 includes a rank indicator (RI), a channel quality indicator (CQI), a total number of non-zero coefficients (NZCs), and the number of SD bases for each TRP of the set of TRPs, and wherein the CSI part 2 includes a per-TRP SD basis selection for each TRP of the set of TRPs or selected TRPs of the set of TRPs.

12. The apparatus of claim 1, wherein the transmitted information comprises a channel state information (CSI) part 1 and a CSI part 2, wherein the CSI part 1 includes a rank indicator (RI), a channel quality indicator (CQI), a total number of non-zero coefficients (NZCs), and a TRP selection indicating selected TRPs of the set of TRPs, wherein the CSI part 2 includes at least the number of SD bases for each TRP of the selected TRPs of the set of TRPs and a per-TRP SD basis selection for the selected TRPs of the set of TRPs.

13. An apparatus for wireless communication at a user equipment (UE), comprising
a memory; and
at least one processor coupled to the memory and, based at least in part on information stored in the memory, the at least one processor is configured to:
receive information indicating a number of spatial domain (SD) bases for each transmission reception point (TRP) of a set of TRPs, the received information being unassociated with a first parameter indicating a number of frequency domain (FD) bases and a second parameter indicating a maximum number of non-zero coefficients (NZCs); and
transmit a channel state information (CSI) report based on the received information.

14. The apparatus of claim 13, wherein the first parameter is based on a number of TRPs of the set of TRPs.

15. The apparatus of claim 13, wherein the CSI report comprises a CSI part 1 and a CSI part 2, wherein the CSI part 1 includes a rank indicator (RI), a channel quality indicator (CQI), a total number of NZCs, and a TRP selection indicating selected TRPs of the set of TRPs, wherein the CSI part 2 includes at least a per-TRP SD basis selection for the selected TRPs of the set of TRPs.

16. A method of wireless communication at a user equipment (UE), comprising:
transmitting information indicating a number of spatial domain (SD) bases for each transmission reception point (TRP) of a set of TRPs; and
receiving a downlink communication from at least a subset of TRPs of the set of TRPs based on the transmitted information.

17. The method of claim 16, further comprising determining a number of frequency domain (FD) bases for each TRP of the set of TRPs based on at least one of the number of SD bases for each TRP of the set of TRPs or a number of TRPs of the set of TRPs, wherein receiving the downlink communication from the at least the subset of TRPs is further based on the determined number of FD bases for each TRP of the set of TRPs.

18. The method of claim 17, wherein the determined number of FD bases for each TRP of the set of TRPs is a same number.

19. The method of claim 17, wherein the determined number of FD bases for each TRP of the set of TRPs is a specific number to each respective TRP.

20. The method of claim 16, wherein a sum of each number of SD bases for each TRP of the set of TRPs is equal to a total number of SD bases Lₜₒₜ, and wherein the transmitted information further includes an actual number of SD bases L_{tot,actual}, which is less than the total number of SD bases Lₜₒₜ.

21-30. (canceled)
